(19) United States
(12) Patent Application Publication
(10) Pub. No.: US 2024/0402088 A1
(43) Pub. Date: Dec. 5, 2024

(54) METHODS AND DEVICES FOR PERFORMING AN ANALYTICAL MEASUREMENT

(71) Applicant: Roche Diabetes Care, Inc., Indianapolis, IN (US)

(72) Inventors: Max Berg, Mannheim (DE); Fredrik Hailer, Limburgerhof (DE); Bernhard Limburg, Soergenloch (DE)

(21) Appl. No.: 18/799,281

(22) Filed: Aug. 9, 2024

Related U.S. Application Data
(63) Continuation of application No. PCT/EP2023/053168, filed on Feb. 9, 2023.

(30) Foreign Application Priority Data
Feb. 11, 2022 (EP) 22 156 299.4

(51) Int. Cl. G01N 21/78; G01N 21/77; G06T 7/90

(52) U.S. Cl. CPC G01N 21/78; G06T 7/90; G01N 2021/7759; G01N 2201/13; G06T 2207/10024; G06T 2207/20081

(57) ABSTRACT

A determination method of determining a dynamic coefficient of variation limit (Cv_{TR, lim}) for assessing validity of an optical test strip usable for an analytical measurement based on a color formation reaction is disclosed. Training sets of optical test strips and mobile devices are provided. A color reference card is also provided. Images are captured of reagent test regions of the optical test strip and of a color reference field(s) of the reference card. A training set of pairs of reagent test region coefficients of variation (Cv_{TR}) and corresponding minimum color reference field coefficients of variation (Cv_{RF, min}) are determined. A relation for determining the dynamic coefficient of variation limit (Cv_{TR, lim}) for the respective reagent test region is derived. The dynamic coefficient of variation limit (Cv_{TR, lim}) defines a maximum coefficient of variation (Cv_{TR, max}) for reagent test regions of non-corrupted optical test strips.

### RELATED APPLICATIONS

This application is a continuation of International Application Serial No. PCT/EP2023/053168, filed Feb. 9, 2023, which claims priority to European Patent Application Serial No. 22 156 299.4, filed Feb. 11, 2022, the entire disclosures of both of which are hereby incorporated herein by reference.

### BACKGROUND

The present application refers to a determination method of determining a dynamic coefficient of variation limit for assessing validity of an optical test strip usable for an analytical measurement based on a color formation reaction. This disclosure further relates to a measurement method of performing an analytical measurement. This disclosure further relates to a determination system for determining a dynamic coefficient of variation limit for assessing validity of an optical test strip usable for an analytical measurement based on a color formation reaction. This disclosure further relates to a mobile device, computer programs and computer-readable storage media. This disclosure may be used in medical diagnostics, specifically in order to qualitatively or quantitatively detect one or more analytes in one or more body fluids. However, other fields of application of this disclosure are also feasible.

In the field of medical diagnostics, in many cases, one or more analytes have to be detected in samples of a body fluid, such as blood, interstitial fluid, urine or saliva. Examples of analytes to be detected are glucose, triglycerides, lactate, cholesterol or other types of analytes typically present in these body fluids. According to the concentration and/or the presence of the analyte, an appropriate treatment may be chosen, if necessary. Without narrowing the scope, this disclosure specifically may be described with respect to blood glucose measurements. It shall be noted, however, that this disclosure may also be used for other types of analytical measurements using test elements.

Generally, devices and methods known to the skilled person make use of test elements comprising one or more test chemistries, which, in presence of the analyte to be detected, are capable of performing one or more detectable detection reactions, such as optically detectable detection reactions. With regard to these test chemistries, reference may be made, e.g., to J. Hoenes et al.: The Technology Behind Glucose Meters: Test Strips, Diabetes Technology & Therapeutics, Volume 10, Supplement 1, 2008, S-10 to S-26. Other types of test chemistry are possible and may be used for performing this disclosure.

In analytical measurements, specifically analytical measurements based on color formation reactions, one technical challenge resides in the evaluation of the color change which is due to the detection reaction. Besides using dedicated analytical devices, such as handheld blood glucose meters, the use of generally available consumer-electronics such as smart phones, tablets or other mobile devices has become more and more popular over the recent years. Thus, a camera comprised by these mobile devices may be used to measure the color change of the detection reaction.

KR 2019/0091325 A discloses a method, device and system for detecting the gastrointestinal (GI) tract.

WO 2013/062487 A1 discloses embodiments relating to a method to identify an object comprising: receiving an image, the image having an object in front of a background; segmenting the image into a segmented image using a segmentation technique, the segmented image having a foreground component showing at least a part of the object and a background component showing at least a part of the background; determining at least one property of the foreground component of the segmented image; and matching the at least one property of the foreground component with a database of identified objects having the corresponding at least one property to identify the object.

Despite the advantages achieved by the known methods and devices, several technical challenges remain. Typically, mobile devices such as smart phones or tablets are not specifically dedicated to analytical measurements. They normally are private consumer-electronics fulfilling a variety of purposes. Only one of the many purposes a mobile device may be used for may be taking images. For this reason, the quality of such images typically is lower compared to analytical measurement setups. Further, not every user may use the same type of mobile device, e.g., the same smart phone, and properties of the mobile devices may vary from device to device. Thus, specifically, the image noise may vary for different mobile devices. As an example, the resolution of cameras of different smart phones may vary, so that analytical measurements may be subject to systematic deviations. Even when using the same mobile device, the quality of the images captured with the camera of the mobile device may vary, e.g., due to different illumination. Thus, the quality of the images may depend on varying environmental conditions in a user's everyday life. Specifically, the environmental conditions in a user's everyday life may also often not be suitable for capturing high quality images. All these factors can negatively impact accuracy and reliability of the analytical measurements.

### SUMMARY

This disclosure provides methods and devices which at least partially address the above-mentioned technical challenges. Specifically, this disclosure teaches user-friendly methods and devices which ensure accurate and reliable analytical measurements when using mobile devices such as consumer-electronics.

As used in the following, the terms “have,” “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B,” “A comprises B” and “A includes B” may both refer to a situation in which, besides B, no other element is present in A (i.e., a situation in which A solely and exclusively consists of B) and to a situation in which, besides B, one or more further elements are present in entity A, such as element C, elements C and D or even further elements.

Further, it shall be noted that the terms “at least one,” “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once. It shall also be understood for purposes of this disclosure and appended claims that, regardless of whether the phrases “one or more” or “at least one” precede an element or feature appearing in this disclosure or claims, such element or feature shall not receive a singular interpretation unless it is made explicit herein. By way of non-limiting example, the terms “camera,” “color channel” and “color reference card,” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

Further, as used in the following, the terms “preferably,” “more preferably,” “particularly,” “more particularly,” “specifically,” “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of this disclosure, a determination method of determining a dynamic coefficient of variation limit (Cv_{TR, lim}) for assessing validity of an optical test strip usable for an analytical measurement based on a color formation reaction is disclosed. The determination method comprises the following steps which, as an example, may be performed in the given order. It shall be noted, however, that a different order may generally also be possible. Further, it may also be possible to perform one or more of the method steps once or repeatedly. Further, it may be possible to perform two or more of the method steps simultaneously or in a timely overlapping fashion. The determination method may comprise further method steps which are not listed.

The determination method comprises:
a) at least two of the optical test strips are non-corrupted and wherein at least two of the optical test strips are corrupted;
b) providing a training set of mobile providing a training set of optical test strips, each optical test strip having a reagent test region, wherein devices, each mobile device having at least one camera;
c) providing at least one color reference card having a plurality of color reference fields having known reference color values;
d) capturing, by using the mobile devices of the training set of mobile devices, a training set of images, wherein each image of the training set of images comprises at least a part of at least one reagent test region of an optical test strip of the training set of optical test strips and at least a part of at least one color reference field of the color reference card;
e) determining, specifically by using at least one processor, more specifically at least one processor of the mobile device, for at least one color channel of the cameras of the mobile devices of the training set of mobile devices, a training set of pairs of reagent test region coefficients of variation (Cv_{TR}) and corresponding minimum color reference field coefficients of variation (Cv_{RF, min}), wherein each reagent test region coefficient of variation (Cv_{TR}) is determined by measuring a color variation within the reagent test region, wherein each color reference field coefficient of variation (Cv_{RF}) is determined by measuring a color variation within the color reference field, wherein a minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields of which a common image was captured together with the corresponding reagent test region; and
f) deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}), wherein the dynamic coefficient of variation limit (Cv_{TR, lim}) defines a maximum coefficient of variation (Cv_{TR, max}) for reagent test regions of non-corrupted optical test strips.

The term “variation” as used herein is a broad term and is to be given its ordinary and customary meaning to a person of ordinary skill in the art and is not to be limited to a special or customized meaning. The term specifically may refer, without limitation, to at least one of a statistical uncertainty, a statistical width of a distribution and a dispersion of a distribution or to fluctuations or deviations within a distribution. The variation may be described by various mathematical parameters which are generally known to the skilled person in the field of statistics. The distribution may for instance comprise a distribution over a 1-dimensional or a multi-dimensional space, such as a 2-dimensional or a 3-dimensional space, or a distribution over time or a distribution over space and time. Specifically, the variation may comprise a spatial color variation over an image. Thus, the distribution may refer to a spatial color distribution within an image, wherein color values, e.g., expressed by using the RGB color space or any other color coordinate space, may spatially vary over pixels of the image. The variation may specifically be expressed quantitatively, e.g., by any statistical parameter describing the variation. As an example, the variation may be described by using at least one parameter describing a statistical deviation of the color values from an average of the distribution. The average may for instance comprise a mean, e.g., an arithmetic mean or a root mean square, or a median. As an example, for a color distribution within an image, one color channel, e.g., a red channel within the RGB color space, may be considered and a mean red value may be determined by using the red values of all pixels within the image. Other color channels, other color spaces or other stochastic evaluation methods may also be applicable and are known to the skilled person. The variation may further generally be expressed quantitatively by using a variance of a distribution, as commonly applied in the field of stochastics, or a quantity derived from the variance such as a standard deviation σ. Specifically, the variation may be expressed quantitatively by using a coefficient of variation also referred to as relative standard deviation. Further options may also be feasible.

The term “coefficient of variation” (Cv) as used herein is a broad term and is to be given its ordinary and customary meaning to a person of ordinary skill in the art and is not to be limited to a special or customized meaning. The term specifically may refer, without limitation, to a standardized measure of dispersion of a distribution, wherein the coefficient of variation may specifically be standardized by using a mean of the distribution. Further, the coefficient of variation may specifically be a relative measure of dispersion of a distribution, specifically relative to a mean of the distribution. The coefficient of variation may specifically be a dimensionless number. More specifically, the coefficient of variation may be defined as a ratio of a standard deviation a of a distribution divided by a mean of the distribution:

$$Cv = \frac{σ}{μ} .$$

Other statistical parameters may also be used as the coefficient of variation, as the skilled person will know. Thus, the coefficient of variation may generally describe a variation, e.g., a color variation in an image as indicated above, e.g., in one or more dimensions. As further indicated, in an image, a mean and a standard deviation may be determined for a color channel, e.g., by using RGB values of pixels of the image or similar methods. Then, as an example, the coefficient of variation for the image may be determined by dividing the determined standard deviation by the determined mean.

The term “limit” as used herein is a broad term and is to be given its ordinary and customary meaning to a person of ordinary skill in the art and is not to be limited to a special or customized meaning. The term specifically may refer, without limitation, to at least one of a threshold, a boundary, a margin, a limitation and a restriction of an entity. The entity may comprise at least one physical quantity or at least one quantity derived therefrom, specifically the coefficient of variation. Thus, the coefficient of variation limit may specifically refer to a limit of the coefficient variation. The coefficient of variation limit may separate optical test strips fit for being used for the analytical measurement from optical test strips unfit for being used for the analytical measurement. The coefficient of variation limit may limit or restrict the coefficient of variation, specifically upwards. The coefficient of variation limit may comprise at least one extreme value, specifically a maximum value, for the coefficient of variation. Generally, the limit may comprise at least one including endpoint meaning that an entity is allowed to be equal to the limit. Additionally or alternatively, the limit may comprise at least one excluding endpoint meaning that an entity is not allowed to be equal to the limit. The limit may be a dynamic limit. The limit may be a defined limit. Specifically, the limit may be defined by using at least one relation, e.g., a function, as will be outlined in further detail below. Thus, the limit may be a function output depending on at least one input variable, wherein the limit may specifically change with a varying input variable.

The term “dynamic” as used herein is a broad term and is to be given its ordinary and customary meaning to a person of ordinary skill in the art and is not to be limited to a special or customized meaning. The term specifically may refer, without limitation, to being at least one of variable, adaptable, adjustable, customizable, changeable and modifiable. In contrast to a static or fixed entity, a dynamic entity may be subject to change, specifically if required or if desired. Specifically, the dynamic entity may be adaptable according to varying environmental conditions. Thus, the dynamic entity may specifically be able to better respond to varying environmental conditions. As indicated, the dynamic entity, e.g., a dynamic limit, may be a relation relating the dynamic entity with at least one environmental condition. Specifically, the dynamic entity may be a function depending on at least one input variable. The input variable may specifically represent at least one environmental condition. Additionally or alternatively, specifically in the context of the dynamic coefficient of variation limit described in further detail below, the input variable may specifically be a type of a mobile device. Generally, the environmental condition may relate to an arbitrary entity influencing or affecting the dynamic entity.

Consequently, the term “dynamic coefficient of variation limit” as used herein is a broad term and is to be given its ordinary and customary meaning to a person of ordinary skill in the art and is not to be limited to a special or customized meaning. The term specifically may refer, without limitation, to a dynamic limit of a coefficient of variation. The dynamic coefficient of variation limit may specifically allow adapting to changing environmental conditions in order to better respond to a present situation. Generally, different coefficient of variation limits may be better suited for different situations. It may thus be detrimental to use a static coefficient of variation irrespective of varying environmental conditions. As an example, two images may be captured and used for assessing validity of an optical test strip usable for an analytical measurement based on a color formation reaction: a first image and a second image. The first image may for instance have lower image noise or be sharper than the second image, e.g., because it was captured with a different camera having a higher resolution or because it was captured under better illumination. A first coefficient of variation may be determined for the first image and a second coefficient of variation may be determined for the second image as indicated above. A static coefficient of variation limit may then limit both the first coefficient of variation and the second coefficient of variation equally. A dynamic coefficient of variation limit may treat the first image and the second image differently, specifically while considering different environmental conditions which were present when the images were captured, e.g., a use of different cameras or a different illumination. For assessing validity of an optical test strip usable for an analytical measurement based on a color formation reaction, the dynamic coefficient of variation limit may specifically set an appropriate limit corresponding to a present situation. Thus, specifically corrupted optical test strips leading to false measurement results may be identified more accurately by using a dynamic coefficient, which can, specifically in the context of blood glucose measurements, possibly be life-saving.

The term “validity” as used herein is a broad term and is to be given its ordinary and customary meaning to a person of ordinary skill in the art and is not to be limited to a special or customized meaning. The term specifically may refer, without limitation, to an admissibility or a permissibility of an entity. The validity may be or comprise at least one criterion, e.g., a quality criterion, assessing the entity. Depending on the outcome of the assessment, the entity may be regarded as valid or admissible, e.g., for one or more follow-up processes, if the entity fulfills the criterion, or the entity may be regarded as invalid or inadmissible, if the entity does not fulfill the criterion. Assessing the validity may specifically comprise a comparison, e.g., with at least one limit, specifically with the dynamic coefficient of variation limit. Specifically, assessing the validity may comprise determining whether a coefficient of variation is below the dynamic coefficient of variation limit, at the dynamic coefficient of variation limit, or above the dynamic coefficient of variation limit. As an example, a coefficient of variation above the dynamic coefficient of variation limit, or optionally also at the dynamic coefficient of variation limit, may be regarded as invalid, which may result in aborting a process, e.g., using an optical test strip for an analytical measurement. Thus, corrupted optical test strips may be identified preventing them from being used for analytical measurements.

The term “analytical measurement” as used herein is a broad term and is to be given its ordinary and customary meaning to a person of ordinary skill in the art and is not to be limited to a special or customized meaning. The term specifically may refer, without limitation, to a quantitative and/or qualitative determination of at least one analyte in an arbitrary sample or aliquot of bodily fluid. Specifically, the analytical measurement may comprise determining the concentration of an analyte in a body fluid. The term “body fluid” may also be referred to as “bodily fluid.” For example, the body fluid may comprise one or more of blood, interstitial fluid, urine, saliva or other types of body fluids. The result of the determining of the concentration, as an example, may be a concentration of the analyte and/or the presence or absence of the analyte to be determined. Specifically, as an example, the determination may be a blood glucose measurement, thus the result of the determination may, for example, be a blood glucose concentration. In particular, an analytical measurement result value may be determined by the analytical measurement. The analytical measurement may specifically be performed by using at least one optical test strip.

The term “optical test strip” as used herein is a broad term and is to be given its ordinary and customary meaning to a person of ordinary skill in the art and is not to be limited to a special or customized meaning. The term specifically may refer, without limitation, to an arbitrary element or device configured for performing a color formation reaction. The optical test strip may also be referred to as test strip or test element, wherein all three terms may refer to the same element. The optical test strip may particularly have a reagent test region, also referred to as test field, comprising at least one test chemical for detecting at least one analyte. The optical test strip, as an example, may comprise at least one substrate, such as at least one carrier, with the at least one test field applied thereto or integrated therein. In particular, the optical test strip may further comprise at least one white area, such as a white field, specifically in a proximity to the test field, for example, enclosing or surrounding the test field. The white area may be a separate field independently arranged on the substrate or carrier. However, additionally or alternatively, the substrate or carrier itself may be or may comprise the white area. As an example, the at least one carrier may be strip-shaped, thereby rendering the test element a test strip. These test strips are generally widely in use and available. One test strip may carry a single test field or a plurality of test fields having identical or different test chemicals comprised therein.

As indicated, the optical test strip may be corrupted or, otherwise, non-corrupted. The term “corrupted” as used herein is a broad term and is to be given its ordinary and customary meaning to a person of ordinary skill in the art and is not to be limited to a special or customized meaning. The term specifically may refer, without limitation, to being at least one of damaged, defective or faulty. Thus, the term “non-corrupted” may specifically refer to being at least one of intact, undamaged or faultless, specifically at least up to a predefined tolerance. A corrupted entity, specifically a corrupted optical test strip, may specifically be negatively affected to a non-tolerable extent.

A corrupted optical test strip, specifically, may be a test strip having at least one parameter being out of a predetermined or determinable tolerance range defining non-corrupted optical test strips. The parameter may be an intrinsic or extrinsic parameter. Therein, an intrinsic parameter may, as an example, refer to a property of the optical test strip itself, whereas an extrinsic parameter may, as an example, refer to a parameter describing a handling of the optical test strip or a use of the optical test strip. Consequently, a corrupted test strip may be corrupted per se and/or may be corrupted by inappropriate handling. The inappropriate handling, as an example, may refer to storage conditions, such that the extrinsic parameter may, as an example, refer to a parameter describing one or more storage conditions, such as a storage temperature and/or a storage time. Additionally or alternatively, the inappropriate handling may refer to a time which has passed since an application of at least one sample of at least one bodily fluid to the optical test strip, specifically to the at least one reagent test region. As an example, the time elapsed between applying the sample to the reagent test region and capturing at least one image comprising at least a part of the at least one reagent test region having the sample applied thereto may have to be in a predetermined tolerance range. Thus, as soon as the time is outside the tolerance range, the optical test strip is corrupted, e.g., as soon as the time which has elapsed since applying the sample has passed a time window within which a tolerable measurement has to take place, i.e., within which at least one image is supposed to be captured.

Thus, generally, a corrupted optical test strip may, without limitation, be an optical test strip which is a priori or per se corrupted, and/or a test strip which is being handled incorrectly, e.g., by using the test strip in a non-compliant manner, such as by capturing the respective image at an inappropriate point in time. Therein, two situations of corruption are generally conceivable, which may also occur in combination:
a) the optical test strip being corrupted per se, such as by degradation, faulty material properties, impact of detrimental environmental effects, such as humidity, expiry of shelf life or the like; and/or
b) the optical test strip being corrupted by inappropriate handling and/or use, such as by being used in a measurement performed with one or more measurement parameters out of at least one tolerance range, such as by capturing at least one image comprising at least a part of at least one test region of the optical test strip at an inappropriate point in time, such as outside a tolerance range of times, e.g., with a time elapsed between sample application and capturing of the image being greater than a maximum delay, and/or due to a pre-use of the optical test strip being dedicated for single-use only.

As an example, a corrupted optical test strip may have been subject to a harmful environment negatively affecting the optical test strip. As an example, a corrupted optical test strip may have been subject to pre-use, wherein the pre-use may specifically render the optical test strip unusable for an accurate and reliable analytical measurement. Further examples and further details will be given below. The harmful environment may have changed at least one property of the optical test strip, specifically of a reagent test region of the optical test strip, which may make the optical test strip unsuitable for reliable analytical measurements. A non-corrupted optical test strip may lead to accurate and reliable results if being used for analytical measurements. A corrupted optical test strip may lead to false and misleading results if being used for analytical measurements. Thus, identifying corrupted optical test strips and aborting analytical measurements before providing potentially false results can often be crucial.

The term “reagent test region” as used herein is a broad term and is to be given its ordinary and customary meaning to a person of ordinary skill in the art and is not to be limited to a special or customized meaning. The term specifically may refer, without limitation, to a coherent amount of the test chemical, such as to a field or a region, e.g., a field of round, polygonal or rectangular shape, having one or more layers of material, with at least one layer of the test field having the test chemical comprised therein. The reagent test region may also be referred to as test field.

As indicated, the analytical measurement may specifically be based on a color formation of the reagent test region. Thus, the analytical measurement may comprise inducing a test reaction between the test chemical and a sample of the bodily fluid or a part thereof, such as the at least one analyte, specifically an analyte-specific test reaction, wherein the test reaction includes a color change of the reagent test region indicative of a degree of the test reaction and/or indicative of a presence or a concentration of the analyte. The color formation may include an arbitrary change of at least one optical property of the optical test strip or, specifically, of the reagent test region, which change may be measured or determined optically by using a camera. Specifically, the analytical measurement may be or may comprise a color formation reaction in the presence of the at least one analyte to be determined.

The term “color formation reaction” as used herein is a broad term and is to be given its ordinary and customary meaning to a person of ordinary skill in the art and is not to be limited to a special or customized meaning. The term specifically may refer, without limitation, to a chemical, biological or physical reaction during which a color, specifically a reflectance, of at least one element involved in the reaction, changes with the progress of the reaction. The color formation may be detected by a mobile device, such as by a processor of the mobile device, and may be evaluated quantitatively, such as by deriving, from the at least one image, at least one parameter quantifying or characterizing the color formation of the reagent test region due to the presence of the analyte in the sample of the bodily fluid. The mobile device and specifically the processor of the mobile device may be configured for determining a color change taking place due to the detection reaction. For such purpose, at least one of the above-mentioned color spaces, e.g., the RGB color space, may be used. As an example, the processor may be configured for determining and processing RGB values of pixels of an image. Further options, specifically alternative color spaces, may also be feasible. At least one analyte concentration value may be determined from the color formation of the reagent test region. The analyte concentration value, as an example, may be a numerical value indicator of a result of the analytical measurement, such as indicative of the concentration of at least one analyte in the sample, such as a blood glucose concentration.

As said, the determination method comprises providing a training set of optical test strips. The term “training” as used herein is a broad term and is to be given its ordinary and customary meaning to a person of ordinary skill in the art and is not to be limited to a special or customized meaning. The term specifically may refer, without limitation, to a process of determining, specifically by experiment, at least one relation, specifically by learning and/or determining at least one parameter of the relation, such as for instance parameters of a function equation. The term “training” may further specifically refer, without limitation, to a process of building a model such as a trainable model, in particular determining parameters, in particular weights, of the model. As will be outlined in further detail below, the relation may for instance comprise a look-up table or a model or a function. As an example, a look-up table may be determined by writing down values which belong together. As a further example, a model may be determined by determining weights of the model or regression parameters. As a further example, a function may be determined by determining a function equation. Generally, the training may comprise at least one optimization process or tuning process or fitting process, wherein a parameter combination is determined, specifically by using a training set.

The term “training set” as used herein is a broad term and is to be given its ordinary and customary meaning to a person of ordinary skill in the art and is not to be limited to a special or customized meaning. The term specifically may refer, without limitation, to data used or usable for training purposes. The training set may be known or predetermined. Specifically, the training set may be or may comprise historical experimental data such as previously experimentally determined data. Additionally or alternatively, the training set may comprise theoretical data such as theoretically calculated data, specifically simulated data. As an example, the training set may comprise known function pairs meaning elements of a domain of the function and corresponding elements of a codomain of the function. Based on this, a function mapping the function pairs may be determined by fitting the functions pairs to, e.g., a polynomial such as a linear function by using known regression analysis methods. A variety of other options is also feasible and generally known to the skilled person. As the skilled person will further already know, the training set may specifically be a sufficiently large training set, e.g., comprise many function pairs, for better training, e.g., for determining a function with less statistical deviation from the function pairs. Specifically, the training set may comprise more than only one entity, since this may specifically render fitting impossible. The training set of optical test strips comprises providing at least two non-corrupted optical test strips and at least two corrupted optical test strips. Thus, at least two non-corrupted optical test strips and at least two corrupted optical test strips may be usable for training purposes. This may specifically be suitable for adequate training based on sufficient statistics.

The determination method further comprises providing a training set of mobile devices. The training set of mobile devices may specifically comprise at least two mobile devices, each mobile device having at least one camera. Thus, at least two mobile devices may be usable for training purposes. Specifically, at least two mobile devices of the training set of mobile devices may differ with respect to image noise. More specifically, at least two mobile devices of the training set of mobile devices which are of different type, e.g., two smart phones of different type, may differ with respect to image noise. Thus, the mobile devices of the training set of mobile devices may specifically lead to varying minimum color reference field coefficients of variation (Cv_{RF, min}) within the training set of pairs of reagent test region coefficients of variation (Cv_{TR}) and corresponding minimum color reference field coefficients of variation (Cv_{RF, min}). The term “mobile device” as used herein is a broad term and is to be given its ordinary and customary meaning to a person of ordinary skill in the art and is not to be limited to a special or customized meaning. The term specifically may refer, without limitation, to a mobile electronics device, more specifically to a mobile communication device such as a cell phone or smart phone. Additionally or alternatively, as will be outlined in further detail below, the mobile device may also refer to a tablet computer or another type of portable computer having at least one camera. The mobile device may specifically comprise a consumer electronics device such as a consumer electronics device used by private users in daily life.

The term “camera” as used herein is a broad term and is to be given its ordinary and customary meaning to a person of ordinary skill in the art and is not to be limited to a special or customized meaning. The term specifically may refer, without limitation, to a device having at least one imaging element configured for recording or capturing spatially resolved one-dimensional, two-dimensional or even three-dimensional optical data or information. As an example, the camera may comprise at least one camera chip, such as at least one CCD chip and/or at least one CMOS chip configured for recording images. As used herein, without limitation, the term “image” specifically may relate to data recorded by using a camera, such as a plurality of electronic readings from the imaging device, such as the pixels of the camera chip. The image itself, thus, may comprise pixels, the pixels of the image, e.g., correlating to pixels of the camera chip. Consequently, when referring to “pixels,” reference is either made to the units of image information generated by the single pixels of the camera chip or to the single pixels of the camera chip directly. The image may comprise raw pixel data. For example, the image may comprise data in the RGB or RGGB space, single color data from one of R, G or B pixels, a Bayer pattern image or the like. The image may comprise evaluated pixel data such as a full-color image or an RGB image. The raw pixel data may be evaluated, for example, by using demosaicing algorithms and/or filtering algorithms. These techniques are generally known to the skilled person.

The camera, besides the at least one camera chip or imaging chip, may comprise one or more further elements, such as one or more optical elements, e.g., one or more lenses. As an example, the camera may be a fix-focus camera, having at least one lens which is fixedly adjusted with respect to the camera. Alternatively, however, the camera may also comprise one or more lenses, such as variable lenses, which may be adjusted, automatically or manually. This disclosure specifically shall be applicable to cameras as usually used in mobile applications such as notebook computers, tablets or, specifically, cell phones such as smart phones. Thus, specifically, the camera may be part of a mobile device which, besides the at least one camera, comprises one or more data processing devices such as one or more data processors. Other cameras, however, are feasible.

The camera specifically may be a color camera. Thus, such as for each pixel, color information may be provided or generated, such as color values for three colors R, G, B. A different number, such as a larger number, of color values is also feasible, such as four color values for each pixel, for example, R, G, G, B. Color cameras are generally known to the skilled person. Thus, as an example, the camera chip may consist of a plurality of three or more different color sensors each, such as color recording pixels like one pixel for red (R), one pixel for green (G) and one pixel for blue (B). For each of the pixels, such as for R, G, B, values may be recorded by the pixels, such as digital values in the range of 0 to 255, depending on the intensity of the respective color. Instead of using color triples such as R, G, B, as an example, quadruples may be used, such as R, G, G, B. The color sensitivities of the pixels may be generated by color filters or by appropriate intrinsic sensitivities of the sensor elements used in the camera pixels. These techniques are generally known to the skilled person.

The mobile device may further, besides the camera, comprise at least one processor. The term “processor” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations.

The determination method further comprises providing at least one reference card having a plurality of color reference fields, the color reference fields having known reference color values. The term “color reference card” as used herein is a broad term and is to be given its ordinary and customary meaning to a person of ordinary skill in the art and is not to be limited to a special or customized meaning. The term specifically may refer, without limitation, to an arbitrary item having, disposed therein or disposed thereon, such as on at least one surface, at least one color reference field having known color properties or optical properties, such as having one or more colored fields having known color such as a known color value or known color coordinates. As an example, the color reference card may be a flat card comprising at least one substrate having, on at least one surface and/or disposed therein, at least one color reference field having a known color value or color coordinate. The substrate, specifically, may have a flat surface with the color reference fields disposed thereon. The substrate, as an example, may be or may comprise one or more of a paper substrate, a cardboard substrate, a plastic substrate, a ceramic substrate or a metal substrate. Laminate substrates are also possible. The substrate, as an example, may be sheet-like or flexible. It shall be noted, however, that the substrate may also be implemented into an article of use, such as into a wall of a box, a vial, a container, a medical consumable, such as a test strip, or the like. Thus, the color reference card may also fully or partially be integrated into an optical test strip, as will be outlined in further detail below. Thus, the at least one image of at least a part of the color reference card may fully or partially comprise an image of at least one part of the optical test strip having at least one reagent test region.

Further, the color reference card may comprise at least one marker. The at least one marker, as an example, may be or may comprise at least one of: an identifier for identifying the color reference card and/or the type of the color reference card, such as at least one of a label, a barcode or a QR-code; a specifier specifying details of the color reference card, such as reference color values or the like, such as by using at least one of a label, a barcode or a QR-code; a position marker and/or orientation marker, such as at least one of a fiducial mark, an ArUco code or the like. Specifically, the at least one marker may be arranged in at least one corner of the color reference card. Thus, the mobile device may be configured for detecting and/or reading the marker, specifically by optically detecting the marker on at least one image, and optionally retrieving information from the marker, such as information on the type, the properties or the orientation of the color reference card.

The term “color reference field” as used herein is a broad term and is to be given its ordinary and customary meaning to a person of ordinary skill in the art and is not to be limited to a special or customized meaning. The term specifically may refer, without limitation, to an arbitrary item having known optical properties, such as a known reference color value. Specifically, a color reference field comprised by the color reference card may be a 2-dimensional structure, such as a rectangle, a square, a polygon, a circle and/or an ellipse, with a uniform color value. The color value of the color reference field specifically may be one or more of predetermined, known or determinable. The color reference field may be comprised by a surface of the color reference card and/or disposed therein, specifically in such a way that the at least one color reference field may be visible in an image captured of the color reference card. Further, the color reference fields may have color values in a subspace of the color coordinate system corresponding to the color space of the color formation reaction of the reagent test region. The color reference fields of the color reference card specifically may be arranged in a regular pattern on the surface of the color reference card, such as in a rectangular pattern, e.g., a rectangular matrix pattern. The pattern arrangement specifically may enable identifying the color reference fields, such as by searching at a predetermined distance in an x- and/or y-direction from one or more of the markers.

The term “color value” as used herein is a broad term and is to be given its ordinary and customary meaning to a person of ordinary skill in the art and is not to be limited to a special or customized meaning. The term specifically may refer, without limitation, to a numerical indication of a color of a pixel, an object or the like. Specifically, the color value may be or may comprise at least one value of at least one color coordinate in a color coordinate system. The term “color coordinate system” as used herein is a broad term and is to be given its ordinary and customary meaning to a person of ordinary skill in the art and is not to be limited to a special or customized meaning. The term specifically may refer, without limitation, to an arbitrary coordinate system by which a color of an object, such as a color of a test field or a color of an image recorded by a camera, may be characterized, such as mathematically or physically. Various color coordinate systems are generally known to the skilled person, such as color coordinate systems defined by CIE. The color coordinates, in their entirety, may span or define a color space, such as by defining three or four basis vectors. For example, the color coordinates may comprise R, G, B color coordinates. Thus, the color value may be a color triple having R, G, B color coordinates. Color coordinates in other color coordinate systems, such as the color coordinate system defined by CIE 1931 or the like, are also feasible.

The term “known reference color value” as used herein is a broad term and is to be given its ordinary and customary meaning to a person of ordinary skill in the art and is not to be limited to a special or customized meaning. The term specifically may refer, without limitation, to a predetermined, real or true color value of a color reference field. Specifically, the known reference color value may comprise one or more known color coordinates, such as at least three known color coordinates, such as at least one color coordinate for each R, G, B color. The known reference color value for each color reference field may be stored on a data storage device of the mobile device, for example, by a look-up table, a register, a database or the like. The known reference color values may have been determined by measuring the respective color values, specifically by measuring the color values in a controlled laboratory environment, such as by using a photospectrometer. The measurement of the color reference fields using a photospectrometer may define the respective known reference color values.

Further, the known reference color values of one or more second color reference fields may also be determined from the known reference color value of a first color reference field. Specifically, a predetermined and/or known relationship may relate the known reference color value of the first color reference field to the known reference color value of the second reference field. Thus, the color reference card may comprise color reference fields having known reference color values, wherein the known reference color values may be related to each other. For example, the second color reference field may have a known reference color value comprising at least one color coordinate, such as one of the R, G, B color coordinates, which is 10 percent higher than at least one color coordinate comprised by the known reference color value of the first color reference field. Further, a third color reference field may have a known reference color value comprising at least one color coordinate, such as one of the R, G, B color coordinates, which is 20 percent higher than at least one color coordinate comprised by the known reference color value of the first color reference field. Thus, the known reference color value of the first color reference field may be known and may further be used for determining the known reference color values of one or more second color reference fields.

The term “color channel” as used herein is a broad term and is to be given its ordinary and customary meaning to a person of ordinary skill in the art and is not to be limited to a special or customized meaning. The term specifically may refer, without limitation, to a primary color of a color space, wherein the primary color may be used for storing an image digitally, e.g., a wavelength in which the image was captured. By using, specifically by combining or mixing, the primary colors of a color space, the further colors of the color space may generated. As an example, the RGB color space comprises 3 color channels: a red color channel (R), a green color channel (G) and a blue color channel (B). Other options are feasible.

The determination method further comprises capturing a training set of images by using the mobile devices of the training set of mobile devices. The term “capturing a training set of images” or any grammatical variation thereof as used herein is a broad term and is to be given its ordinary and customary meaning to a person of ordinary skill in the art and is not to be limited to a special or customized meaning. The term specifically may refer, without limitation, to capturing images forming a training set of images. Specifically, the images of the training set of images may be captured by using different mobile devices of the training set of mobile devices, specifically at least two mobile devices of the training set of mobile devices. More specifically, each mobile devices of the training set of mobile devices may be used for capturing at least one image of the training set of images. As an example, all mobile devices of the training set of mobile devices may contribute the same number of images to the training set of images. However, the mobile devices of the training set of mobile devices may also at least partially contribute a different number of images to the training set of images. As an example, the training set of mobile devices may comprise 3 mobile devices, wherein a first mobile device and a second mobile device may each contribute 10 images to the training set of images and wherein a third mobile device may contribute 20 images to the training set of images. Specifically, the training set of images may comprise at least one captured image for each mobile devices of the training set of mobile devices. Other options are feasible.

The term “capturing at least one image” or any grammatical variation thereof as used herein is a broad term and is to be given its ordinary and customary meaning to a person of ordinary skill in the art and is not to be limited to a special or customized meaning. The term specifically may refer, without limitation, to one or more of imaging, image recording, image acquisition, image capturing. The term “capturing at least one image” may comprise capturing a single image and/or a plurality of images such as a sequence of images. For example, the capturing of the image may comprise recording continuously a sequence of images such as a video or a movie. The capturing of the at least one image may be initiated by the user action or may automatically be initiated, e.g., once the presence of the at least one object within a field of view and/or within a predetermined sector of the field of view of the camera is automatically detected. These automatic image acquisition techniques are known e.g., in the field of automatic barcode readers, such as from automatic barcode reading apps. The capturing of the images may take place, as an example, by acquiring a stream or “live stream” of images with the camera, wherein one or more of the images, automatically or by user interaction such as pushing a button, are stored and used as the at least one first image or the at least one second image, respectively. The image acquisition may be supported by a processor of the mobile device, and the storing of the images may take place in a data storage device of the mobile device.

Each image of the training set of images comprises at least a part of at least one reagent test region of an optical test strip of the training set of optical test strips. Each image of the training set of images further comprises at least a part of at least one color reference field of the color reference card. Specifically, each image of the training set of images may comprise a complete reagent test region and at least one complete color reference field. More specifically, each image of the training set of images may comprise a complete reagent test region and a complete color reference card. A color reference card may for instance comprise 20 color reference fields. As an example, when capturing the image, the reagent test region and the color reference card may be in the field of view of the camera and, thus, at least a part of the reagent test region and at least a part of the color reference card may be visible in the at least one image. When capturing an image, the optical test strip and the color reference card may specifically be positioned next to each other, e.g., adjacent to each other. As an example, the optical test strip may be placed on top of the color reference card, and/or the color reference card may comprise one or more windows, wherein the color reference card, with the one or more windows, is placed on top of the optical test strip such that the reagent test region is visible through the window. As will also be outlined below, an optical test strip may more specifically be attached to a color reference card before capturing an image.

The determination method further comprises determining, for at least one color channel of the cameras of the mobile devices of the training set of mobile devices, a training set of pairs of reagent test region coefficients of variation (Cv_{TR}) and corresponding minimum color reference field coefficients of variation (Cv_{RF, min}). As said, each image of the training set of images comprises at least a part of at least one reagent test region of an optical test strip of the training set of optical test strips. The at least one part of the image showing the at least one part of the at least one reagent test region of the optical test strip may be identified, e.g., by image recognition. Specifically, for each image of the training set of images, a reagent test region coefficient of variation (Cv_{TR}) may be determined. The reagent test region coefficient of variation (Cv_{TR}) is determined by measuring a color variation within the reagent test region. As an example, RGB values of pixels of the image may be used for this purpose as outlined above, e.g., red color values for a red color channel. Thus, as outlined above, the at least one part of the image showing the at least one part of the at least one reagent test region of the optical test strip may be identified, e.g., by image recognition, and the color variation within said part of the respective image may be determined. Analogously, as said, each image of the training set of images further comprises at least a part of at least one color reference field of the color reference card. Specifically, for each image of the training set of images, a minimum color reference field coefficient of variation (Cv_{RF, min}) may be determined. Additionally or alternatively, as an example, for each image of the training set of images, an average color reference field coefficient of variation (Cv_{RF, ave}) may be determined and used further on. Other indicators besides a minimum and an average are also feasible. However, without narrowing the scope, this disclosure specifically may be described with respect to a minimum color reference field coefficient of variation (Cv_{RF, min}). The color reference field coefficient of variation (Cv_{RF}) is determined by measuring a color variation within the color reference field. The color reference field coefficient of variation (Cv_{RF}) may specifically be determined analog to the reagent test region coefficient of variation (Cv_{TR}). As an example, again, the at least one part of the image showing the at least one part of the at least one color reference field of the color reference card may be identified, e.g., by image recognition, and the color variation within said part may be determined. However, another method may also be applicable in principle. As indicated, a color reference card may comprise more than one color reference field. Thus, a color reference field coefficient of variation (Cv_{RF}) may specifically be determined for every color reference field of the color card or at least every color reference field in the image.

A minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields of which a common image was captured together with the corresponding reagent test region. Specifically, for each image of a reagent test region together with a color reference card, one minimum color reference field coefficient of variation (Cv_{RF, min}) may be determined for the color reference fields of the color reference card. This minimum color reference field coefficient of variation (Cv_{RF, min}) may then be assigned to the in parallel determined reagent test region coefficient of variation (Cv_{TR}), thereby forming a pair of a reagent test region coefficient of variation (Cv_{TR}) and a corresponding minimum color reference field coefficient of variation (Cv_{RF, min}).

The determination method further comprises deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}). Thus, eventually, a relation may be determined which may allow to determine, e.g., to calculate, a dynamic coefficient of variation limit (Cv_{TR, lim}) based on a measured minimum color reference field coefficient of variation (Cv_{RF, min}). The term “relation” as used herein is a broad term and is to be given its ordinary and customary meaning to a person of ordinary skill in the art and is not to be limited to a special or customized meaning. The term specifically may refer, without limitation, to an allocation or an assignment of at least one first entity to at least one second entity. As will also be outlined below, the relation may specifically comprise at least one of a lookup-table, a model, an algorithm and a function, specifically a linear function. Specifically, the determination method may determine a function equation for determining a dynamic coefficient of variation limit (Cv_{TR, lim}) based on a measured minimum color reference field coefficient of variation (Cv_{RF, min}) used as function variable. However, other options are also feasible.

The dynamic coefficient of variation limit (Cv_{TR, lim}) defines a maximum coefficient of variation (Cv_{TR, max}) for reagent test regions of non-corrupted optical test strips. Thus, the maximum coefficient of variation (Cv_{TR, max}) may specifically be or comprise a maximum value for a reagent test region coefficient of variation (Cv_{TR}) of an optical test strip, which may be considered to be allowable for using the optical test strip for an analytical measurement. Further, the maximum coefficient of variation (Cv_{TR, max}) may specifically be or comprise a minimum value for a reagent test region coefficient of variation (Cv_{TR}) of an optical test strip, which may be considered to be non-allowable for using the optical test strip for an analytical measurement. Specifically, a reagent test region coefficient of variation (Cv_{TR}) below the dynamic coefficient of variation limit (Cv_{TR, lim}) may be considered to be allowable for an analytical measurement. A reagent test region coefficient of variation (Cv_{TR}) above the dynamic coefficient of variation limit (Cv_{TR, lim}) may be considered to be non-allowable for an analytical measurement. A reagent test region coefficient of variation (Cv_{TR}) equal to the dynamic coefficient of variation limit (Cv_{TR, lim}) may be considered to be either allowable or non-allowable for an analytical measurement depending on predefined default settings.

As indicated, the dynamic coefficient of variation limit (Cv_{TR, lim}) is derived by using the training set of pairs of reagent test region coefficients of variation (Cv_{TR}) and corresponding minimum color reference field coefficients of variation (Cv_{RF, min}). As further indicated, the determination method comprises providing a training set of optical test strips, wherein at least two of the optical test strips are non-corrupted and wherein at least two of the optical test strips are corrupted. Specifically, corrupted optical test strips may yield pairs of reagent test region coefficients of variation (Cv_{TR}) and corresponding minimum color reference field coefficients of variation (Cv_{RF, min}) which are distinguishable from pairs of reagent test region coefficients of variation (Cv_{TR}) and corresponding minimum color reference field coefficients of variation (Cv_{RF, min}) of non-corrupted optical test strips. In other words, pairs of reagent test region coefficients of variation (Cv_{TR}) and corresponding minimum color reference field coefficients of variation (Cv_{RF, min}) of corrupted optical test strips may be distinguishable from pairs of reagent test region coefficients of variation (Cv_{TR}) and corresponding minimum color reference field coefficients of variation (Cv_{RF, min}) of non-corrupted optical test strips, e.g., by using a trainable model such as a decision tree classifier model, a support vector machine model or an artificial neural network. Further options, specifically in the field of machine-learning, are feasible and are generally known to the skilled person.

Specifically, reagent test region coefficients of variation (Cv_{TR}) of corrupted optical test strips may be distinguishable from reagent test region coefficients of variation (Cv_{TR}) of non-corrupted optical test strips. More specifically, reagent test region coefficients of variation (Cv_{TR}) of corrupted optical test strips may be larger compared to reagent test region coefficients of variation (Cv_{TR}) of non-corrupted optical test strips. Corrupted optical test strips, as an example, may be optical test strips selected from the group consisting of: optical test strips having been stored under inappropriate conditions, such as under an elevated temperature, under inappropriately high moisture or the like; optical test strips having exceeded a predetermined shelf lifetime; impure optical test strips; optical test strips which are not unused and/or which have been pre-used. Other ways of corrupting the optical test strips, thereby rendering the optical test strips unfit for usage in analysis, are feasible, such as by subjecting, prior to use for the analytical measurement, the optical test strips to any treatment deviating from a predetermined standard treatment, such as predetermined storage and/or handling conditions. As an example, a corrupted optical test strip may be an optical test strip which was already used previously, specifically by applying a sample of a bodily fluid, e.g., blood, to the reagent test region. This may again increase a color inhomogeneity of the reagent test region. Typically, applied blood produces a grid pattern at the, in this case pre-used, reagent test region. Eventually, this may result in an increased reagent test region coefficient of variation (Cv_{TR}) of the corrupted optical test strip. As will also be outlined below, the pairs of reagent test region coefficients of variation (Cv_{TR}) and corresponding minimum color reference field coefficients of variation (Cv_{RF, min}) may also already be labelled with information on whether the respective optical test strip of the training set of optical test strips is corrupted or non-corrupted.

Further, pairs of reagent test region coefficients of variation (Cv_{TR}) and corresponding minimum color reference field coefficients of variation (Cv_{RF, min}), specifically of non-corrupted optical test strips, may cluster, specifically for different mobile devices of the training set of mobile devices, e.g., for different smart phone cameras. Additionally or alternatively, similar environmental conditions such as similar illumination when capturing images may also contribute to cluster formation. Specifically, minimum color reference field coefficients of variation (Cv_{RF, min}) may be distinguishable for different mobile devices. As an example, a first smart phone camera with a higher image noise may lead to a larger minimum color reference field coefficient of variation (Cv_{RF, min}) compared to a second smart phone camera with a lower image noise. This reflects that different minimum color reference field coefficients of variation (Cv_{RF, min}) may indicate different environmental conditions relevant for determining an adequate dynamic coefficient of variation limit (Cv_{TR, lim}). Thus, an adequate dynamic coefficient of variation limit (Cv_{TR, lim}) may specifically be based on a present measured minimum color reference field coefficient of variation (Cv_{RF, min}).

Overall, pairs of reagent test region coefficients of variation (Cv_{TR}) and corresponding minimum color reference field coefficients of variation (Cv_{RF, min}) of corrupted optical test strips may be identifiable and, analogously, pairs of reagent test region coefficients of variation (Cv_{TR}) and corresponding minimum color reference field coefficients of variation (Cv_{RF, min}) of non-corrupted optical test strips may be identifiable. Thus, for each minimum color reference field coefficient of variation (Cv_{RF, min}), a dynamic coefficient of variation limit (Cv_{TR, lim}) may be derived which excludes at least most of the pairs of reagent test region coefficients of variation (Cv_{TR}) and corresponding minimum color reference field coefficients of variation (Cv_{RF, min}) of corrupted optical test strips and which permits at least most of the pairs of reagent test region coefficients of variation (Cv_{TR}) and corresponding minimum color reference field coefficients of variation (Cv_{RF, min}) of non-corrupted optical test strips, e.g., by using at least one trainable model, specifically a regression model. Further options, specifically in the field of machine-learning, are feasible and are generally known to the skilled person. As will also be outlined below, default settings may for instance be defined on how many of the pairs of reagent test region coefficients of variation (Cv_{TR}) and corresponding minimum color reference field coefficients of variation (Cv_{RF, min}) of corrupted optical test strips the dynamic coefficient of variation limit (Cv_{TR, lim}) shall exclude or on how many of the pairs of reagent test region coefficients of variation (Cv_{TR}) and corresponding minimum color reference field coefficients of variation (Cv_{RF, min}) of non-corrupted optical test strips the dynamic coefficient of variation limit (Cv_{TR, lim}) shall permit.

The determination method may further comprise step g) of applying a sample of bodily fluid to the reagent test region of the optical test strip. Step g) may specifically be performed before step d). Thus, steps d) to f) may be performed by using reagent test regions having, specifically recently, a sample of a bodily fluid applied thereto. Specifically, step g) of applying a sample of bodily fluid to the reagent test region of the optical test strip may be performed less than a 1 minute before capturing an image of the reagent test region according to step d), more specifically less than 30 seconds, most specifically less than 10 seconds. Specifically, the bodily fluid applied in step g) may be of interest for at least one embodiment of a measurement method of performing an analytical measurement based on a color formation reaction by using a mobile device having a camera and a processor as disclosed below in further detail. As an example, the bodily fluid applied in step g) may be blood which may be of interest for blood glucose measurements which may be performed at a later point in time as analytical measurements, wherein the blood glucose measurements may be performed by using the described determination method.

The determination method may further comprise step h) of attaching at least one optical test strip of the training set of optical test strips to the color reference card comprising a plurality of color reference fields having known reference color values. Step h) may be performed before step d) and optionally before step g). The color reference card may comprise at least one receiving portion for the optical test strip. The color card may comprise at least window. The window and/or the receiving portion may be arranged such that the test reagent region is visible through the window, when the optical test strip is received in the receiving portion.

The corrupted optical test strip may be corrupted by at least one of: a previous appliance of a fluid sample, specifically a sample of bodily fluid; a previous exposure to at least one corruptive environment for more than 10 minutes, specifically for more than 2 hours, more specifically for more than 1 day; a time elapsed since application of a fluid sample being out of a tolerance range, specifically a time between sample application and capturing of an image. The previous appliance of the fluid sample, in contrast to step g) of applying a sample of bodily fluid to the reagent test region of the optical test strip, may specifically be performed unintentionally and/or may be performed long before capturing an image of the reagent test region according to step d), specifically more than 15 minutes before, more specifically more than 1 hour before, more specifically more than 1 day before. Specifically, the previous appliance of the fluid sample may refer to a previous and already completed analytical measurement. As an example, a diabetes patient, e.g., an elderly and forgetful person, may perform a first blood glucose measurement by using an optical test strip. At a later point in time, e.g., after a day, the diabetes patient may by accident want to perform a second blood glucose measurement by using the optical test strip again, which could however lead to a false and misleading result, since the optical test strip is corrupted by the previous appliance of blood in the first blood glucose measurement. Thus, stopping and warning the diabetes patient at the second blood glucose measurement may be desirable in this exemplary case. As said, the optical test strip may also be corrupted by a previous exposure to at least one corruptive environment. The corruptive environment may be selected from the group consisting of: a humid environment, specifically an environment having a humidity of more than 60%, more specifically a humidity of more than 80%, and a bright environment, specifically an environment having an illuminance of more than 1000 lm/m², more specifically an illuminance of more than 1500 lm/m².

Step e) may further comprise labelling the pairs of reagent test region coefficients of variation (Cv_{TR}) and corresponding minimum color reference field coefficients of variation (Cv_{RF, min}) of the training set of pairs of reagent test region coefficients of variation (Cv_{TR}) and corresponding minimum color reference field coefficients of variation (Cv_{RF, min}) with information on whether the respective optical test strip of the training set of optical test strips was corrupted or non-corrupted. The labelling may specifically be taken into consideration in step f). The term “labelling” including any grammatical variation thereof as used herein is a broad term and is to be given its ordinary and customary meaning to a person of ordinary skill in the art and is not to be limited to a special or customized meaning. The term specifically may refer, without limitation, to providing at least one entity with at least one item of information on at least one property of the entity. The at least one item of information on at least one property of the entity is also referred to as the “label.” The at least one property of the entity, as an example, may be or may comprise at least one of a recognition sign, an identification sign and an information sign, which may all also be referred to as label. The label may comprise at least one item of information on at least one property of the labeled entity, wherein the item of information may specifically identify the labeled entity. The label may specifically be or may comprise a digital label. Thus, when deriving the relation for determining the dynamic coefficient of variation limit (Cv_{TR, lim}) in step f), it may not be required anymore to initially classify pairs of reagent test region coefficients of variation (Cv_{TR}) and corresponding minimum color reference field coefficients of variation (Cv_{RF, min}) of corrupted optical test strips and non-corrupted optical test strips, respectively.

Thus, step f) may comprise using at least one of a supervised and a semi-supervised learning architecture, e.g., by using a machine learning model and/or a trainable model, specifically at least one deep learning architecture. Further details, specifically with respect to the trainable model, will be given below. The term “deep learning” as used herein is a broad term and is to be given its ordinary and customary meaning to a person of ordinary skill in the art and is not to be limited to a special or customized meaning. The term specifically may refer, without limitation, to a method of using artificial intelligence (AI) for automatic model building. Deep learning may specifically comprise at least one neural network, wherein the neural network may comprise at least one input layer, one output layer and at least one hidden layer between the input layer and the output layer. The term “supervised learning” as used herein is a broad term and is to be given its ordinary and customary meaning to a person of ordinary skill in the art and is not to be limited to a special or customized meaning. The term specifically may refer, without limitation, to a deep learning method using a completely labeled training dataset. The term “semi-supervised learning” as used herein is a broad term and is to be given its ordinary and customary meaning to a person of ordinary skill in the art and is not to be limited to a special or customized meaning. The term specifically may refer, without limitation, to a learning method using a partially labeled training dataset, so that a part of the training dataset may have to be assigned independently based on a built model.

Besides using machine learning, however, other options are also feasible. Thus, as an example, other methods using manual, automatic or semi-automatic methods may be used for deriving the relation in step f).

In step f), the dynamic coefficient of variation limit (Cv_{TR, lim}) may exclude at least 90%, specifically at least 95%, more specifically at least 99%, of the corrupted optical test strips of the training set of optical test strips. In step f), the dynamic coefficient of variation limit (Cv_{TR, lim}) may permit acceptance of at least 80%, specifically at least 90%, more specifically at least 95%, more specifically at least 97%, more specifically at least 99%, of the non-corrupted optical test strips of the training set of optical test strips. In other words, in step f), the dynamic coefficient of variation limit (Cv_{TR, lim}) may not exclude more than 5%, specifically more than 3%, more specifically more than 1%, of the non-corrupted optical test strips of the training set of optical test strips. Thus, in step f), predefined default settings may be used, specifically as boundary conditions, when deriving the relation for determining the dynamic coefficient of variation limit (Cv_{TR, lim}). The term “exclude” including any grammatical variation thereof as used herein is a broad term and is to be given its ordinary and customary meaning to a person of ordinary skill in the art and is not to be limited to a special or customized meaning. The term specifically may refer, without limitation, to rejecting or discarding or eliminating or disqualifying an entity. Specifically, excluding a corrupted optical test strip may refer to classifying or rating the corrupted optical test strip as invalid for an accurate and reliable analytical measurement. Thus, the analytical measurement which may use the corrupted optical test strip may be aborted in order to prevent a user from receiving potentially false and misleading measurement results. The term “permit” including any grammatical variation thereof as used herein is a broad term and is to be given its ordinary and customary meaning to a person of ordinary skill in the art and is not to be limited to a special or customized meaning. The term specifically may refer, without limitation, to allowing or authorizing or admitting an entity. Specifically, permitting a non-corrupted optical test strip or permitting acceptance of a non-corrupted optical test strip may refer to classifying or rating the non-corrupted optical test strip as valid or admissible or suitable for an accurate and reliable analytical measurement. Thus, the analytical measurement may subsequently be carried out by using the non-corrupted optical test strip.

The relation derived in step f) may comprise at least one of a look-up table, a model, an algorithm and a function, including, e.g., one or more one-, two or three-dimensional graphs or surfaces, e.g., one or more hypersurfaces. As an example, the look-up table may hold minimum color reference field coefficients of variation (Cv_{RF, min}) and derived dynamic coefficients of variation limit (Cv_{TR, lim}), e.g., in two columns or rows of the look-up table, specifically in two linked or connected columns or rows of the look-up table. As already indicated, the model may specifically comprise at least one of a regression model and a classifier model. The model may specifically comprise at least one trainable model. Further details on the trainable model will be outlined below. The algorithm may specifically comprise instructions for determining a dynamic coefficient of variation limit (Cv_{TR, lim}) based on a measured minimum color reference field coefficient of variation (Cv_{RF, min}). The instruction may, for example, comprise at least one of a calculation operation, e.g., an addition or multiplication, and a comparison operation, e.g., a comparison between two entities or a request if a specific criterion is met for an entity.

As said, the relation derived in step f) may comprise a function. The term “function” as used herein is a broad term and is to be given its ordinary and customary meaning to a person of ordinary skill in the art and is not to be limited to a special or customized meaning. The term specifically may refer, without limitation, to a relation assigning one or more elements from a first set to elements from at least one second set, wherein each element of the first set is related to exactly one element of the second set. The first set may be referred to as domain of the function. The second set may be referred to as codomain of the function. As already indicated, the function may comprise at least one mathematical function, specifically at least one function equation. The function equation may define at least one calculation operation, e.g., an addition or a multiplication. The function, specifically the function equation, may use a measured minimum color reference field coefficient of variation (Cv_{RF, min}) as a function variable for determining a dynamic coefficient of variation limit (Cv_{TR, lim}) as function output. The function may be graphically representable, e.g., as graph in a two- or three-dimensional coordinate system. The function may be a linear function. Thus, the function may be graphically representable as a geometrical line. The function may specifically be as follows:

Cv_{TR,lim}=a·Cv_{RF,min}+b,

wherein be the parameter “a” may be a slope of the function, wherein the parameter “b” may be an offset of the function. As indicated, the parameters “a” and “b” may be determined by using the training set of images, specifically by using the training set of pairs of reagent test region coefficients of variation (Cv_{TR}) and corresponding minimum color reference field coefficients of variation (Cv_{RF, min}). Further, as an example, at least one machine learning algorithm may be used for determining the parameters “a” and “b.” The linear function may have a slope of 1. Thus, the parameter “a” may be equal to 1. Thus, the dynamic coefficient of variation limit (Cv_{TR, lim}) may specifically be determined by adding an offset to the measured minimum color reference field coefficient of variation (Cv_{RF, min}).

The dynamic coefficient of variation limit (Cv_{TR, lim}) may comprise a predefined maximum coefficient of variation limit (Cv_{TR, max, predefined}) for reagent test regions which is not exceedable. In other words, the predefined maximum coefficient of variation limit (Cv_{TR, max, predefined}) may be a maximum limit for the dynamic coefficient of variation limit (Cv_{TR, lim}), such that the dynamic coefficient of variation limit (Cv_{TR, lim}) can at most be as large as the predefined maximum coefficient of variation limit (Cv_{TR, max, predefined}). Thus, in case the dynamic coefficient of variation limit (Cv_{TR, lim}) may follow a relation which may, at least for one minimum color reference field coefficients of variation (Cv_{RF, min}), output a dynamic coefficient of variation limit (Cv_{TR, lim}) larger than the predefined maximum coefficient of variation limit (Cv_{TR, max, predefined}), the dynamic coefficient of variation limit (Cv_{TR, lim}) may be set back to the predefined maximum coefficient of variation limit (Cv_{TR, max, predefined}). This may again ensure accurate and reliable analytical measurements.

Step f) may comprise using at least one machine-learning algorithm, specifically by training a trainable model by using the training set of pairs of reagent test region coefficients of variation (Cv_{TR}) and corresponding minimum color reference field coefficients of variation (Cv_{RF, min}). The term “trainable model” as used herein is a broad term and is to be given its ordinary and customary meaning to a person of ordinary skill in the art and is not to be limited to a special or customized meaning. The term specifically may refer, without limitation, to a mathematical model for data interpretation, e.g., data classification and/or data evaluation, wherein the trainable model is trainable on at least one training set. In the trainable model, one or more parameters may still be variable, and the setting of the parameters is up to a training process. The trainable model may provide a model of an environment, and the model may be adapted for reacting to stimuli from the environment in an adequate fashion and for adjusting the model in accordance with observed deviations such that, in a subsequent run, the model reacts to stimuli in a more adequate fashion. The trainable model may be trained on at least one training set and may be configured for predicting at least one target variable for at least one input variable, such that, as an example, the at least one input variable forms a stimulus, and the output target variable forms the response of the trainable model. A plurality of trainable models is generally known to the skilled person and is further mentioned throughout this application. Further, the term “trainable model” specifically may refer, without limitation, to a model for predicting accuracy which can be trained on at least one training set, also denoted training data. The method may comprise at least one training step, wherein, in the training step, the trained model is trained on the at least one training set. The trained model may comprise at least one model selected from the group consisting of: a linear regression model, e.g., comprising transformed features, such as log-transformed or polynomial; at least one non-linear Artificial Neural Network (ANN), in particular at least one deep learning architecture such as Convolutional NN, Recurrent NN, Long Short Term Memory NN, and the like; at least one Support Vector Machine (SVM); at least one kernel based method; Tree regression; Random Forest. The trainable model, after performing the training step, may also be referred to as a “trained model.”

Thus, step f) may comprise training a trainable model by using the training set of pairs of reagent test region coefficients of variation (Cv_{TR}) and corresponding minimum color reference field coefficients of variation (Cv_{RF, min}). As an example, step f) may comprise classifying the pairs of reagent test region coefficients of variation (Cv_{TR}) and corresponding minimum color reference field coefficients of variation (Cv_{RF, min}) as being related to corrupted optical test strips or as being related to non-corrupted optical test strips, specifically in case the pairs of reagent test region coefficients of variation (Cv_{TR}) and corresponding minimum color reference field coefficients of variation (Cv_{RF, min}) may not be labeled. Thus, as an example, step f) may for instance comprise applying a classifier model to the pairs of reagent test region coefficients of variation (Cv_{TR}) and corresponding minimum color reference field coefficients of variation (Cv_{RF, min}) for classifying them as being related to corrupted optical test strips or as being related to non-corrupted optical test strips. Further, as an example, step f) may comprise determining a relation for a dynamic coefficient of variation limit (Cv_{TR, lim}) by applying at least one regression model to the classified or labeled pairs of reagent test region coefficients of variation (Cv_{TR}) and corresponding minimum color reference field coefficients of variation (Cv_{RF, min}).

In step e), the pairs of reagent test region coefficients of variation (Cv_{TR}) and corresponding minimum color reference field coefficients of variation (Cv_{RF, min}) may be determined for at least two color channels, specifically for at least two color channels selected from the group consisting of: a green color channel, a blue color channel and a red color channel. More specifically, the pairs of reagent test region coefficients of variation (Cv_{TR}) and corresponding minimum color reference field coefficients of variation (Cv_{RF, min}) may be determined for the green color channel and/or for the red color channel. In step f), the dynamic coefficient of variation limit (Cv_{TR, lim}) may be derived for the at least two color channels for which the pairs of reagent test region coefficients of variation (Cv_{TR}) and corresponding minimum color reference field coefficients of variation (Cv_{RF, min}) are determined in step e). As an example, in step e), the pairs of reagent test region coefficients of variation (Cv_{TR}) and corresponding minimum color reference field coefficients of variation (Cv_{RF, min}) may be determined for the green color channel and, in step f), the dynamic coefficient of variation limit (Cv_{TR, lim}) may be derived for the green color channel. Additionally or alternatively, as an example, in step e), the pairs of reagent test region coefficients of variation (Cv_{TR}) and corresponding minimum color reference field coefficients of variation (Cv_{RF, min}) may be determined for the red color channel and, in step f), the dynamic coefficient of variation limit (Cv_{TR, lim}) may be derived for the red color channel. In case, in step f), the dynamic coefficient of variation limit (Cv_{TR, lim}) is derived for two or more color channels, e.g., the green color channel and the red color channel, a minimum dynamic coefficient of variation limit (Cv_{TR, lim}) of the determined dynamic coefficients of variation limit (Cv_{TR, lim}) for the respective color channels may be used for defining a maximum coefficient of variation (Cv_{TR, max}) for reagent test regions of non-corrupted optical test strips. As an example, for each color channel an individual dynamic coefficient of variation limit (Cv_{TR, lim}) may at first be derived, wherein the individual dynamic coefficient of variation limits (Cv_{TR, lim}) may subsequently be compared with each other.

However, specifically, for each color channel, an individual dynamic coefficient of variation limit (Cv_{TR, lim}) may be derived, wherein, for each color channel, the reagent test region coefficient of variation (Cv_{TR}) may be compared to the individual dynamic coefficient of variation limit (Cv_{TR, lim}) of the color channel, wherein, for a non-corrupted optical test strip, the reagent test region coefficients of variation (Cv_{TR}) may have to be smaller than, or optionally equal to, the individual dynamic coefficient of variation limit (Cv_{TR, lim}) of the color channel for all color channels. In other words, for a corrupted optical test strip, the reagent test region coefficients of variation (Cv_{TR}) may have to be larger than, or optionally equal to, the individual dynamic coefficient of variation limit (Cv_{TR, lim}) of at least one color channel. As an example, the green color channel and the red color channel may be considered. Then, as an example, for a non-corrupted optical test strip, the coefficient of variation (Cv_{TR}) of the green color channel may have to be smaller than, or optionally equal to, the individual dynamic coefficient of variation limit (Cv_{TR, lim}) of the green color channel and the coefficient of variation (Cv_{TR}) of the red color channel may have to be smaller than, or optionally equal to, the individual dynamic coefficient of variation limit (Cv_{TR, lim}) of the red color channel. In other words, for a corrupted optical test strip, the coefficient of variation (Cv_{TR}) of the green color channel may have to be larger than, or optionally equal to, the individual dynamic coefficient of variation limit (Cv_{TR, lim}) of the green color channel or the coefficient of variation (Cv_{TR}) of the red color channel may have to be larger than, or optionally equal to, the individual dynamic coefficient of variation limit (Cv_{TR, lim}) of the red color channel. Further options are also feasible.

The determination method may at least partially be computer-implemented, specifically at least one of steps e) and f). Referring to the computer-implemented aspects of this disclosure, one or more of the method steps or even all of the method steps of the determination method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

In a further aspect of this disclosure, a measurement method of performing an analytical measurement based on a color formation reaction by using a mobile device having a camera and a processor is disclosed. The measurement method comprises the following steps which, as an example, may be performed in the given order. It shall be noted, however, that a different order may generally also be possible. Further, it may also be possible to perform one or more of the method steps once or repeatedly. Further, it may be possible to perform two or more of the method steps simultaneously or in a timely overlapping fashion. The measurement method may comprise further method steps which are not listed.

The measurement method comprises:
i) providing at least one optical test strip having at least one reagent test region, wherein the optical test strip specifically is of the same type of optical test strips as the optical test strips of the training set used in step a) of the determination method according to any one of the embodiments described above or below in further detail referring to a determination method;
ii) providing at least one color reference card having a plurality of color reference fields having known reference color values;
iii) capturing, by using the camera, at least one image of at least a part of the reagent test region having at least one sample of at least one bodily fluid applied thereto and at least a part of at least one of the color reference fields of the color reference card;
iv) determining, specifically by using the processor, for at least one color channel of the camera of the mobile device, a color reference field coefficient of variation (Cv_{RF}) for at least one of the color reference fields by using the image, wherein the color reference field coefficient of variation (Cv_{RF}) is determined by measuring a color variation within the at least one color reference field;
v) determining, specifically by using the processor, a minimum color reference field coefficient of variation (Cv_{RF, min}) for the color reference card by using the at least one color reference field coefficient of variation (Cv_{RF}) determined in step iv);
vi) determining, specifically by using the processor, a dynamic coefficient of variation limit (Cv_{TR, lim}) for the reagent test region by using the minimum color reference field coefficient of variation (Cv_{RF, min}) determined in step v) and by using a relation for determining the dynamic coefficient of variation limit (Cv_{TR, lim}), wherein the relation is determined by performing the determination method according to any one of the embodiments described above or below in further detail referring to a determination method;
vii) determining, specifically by using the processor, for the at least one color channel, a reagent test region coefficient of variation (Cv_{TR}) of the reagent test region by using the image, wherein the reagent test region coefficient of variation (Cv_{TR}) is determined by measuring a color variation within the reagent test region;
viii) comparing, for the at least one color channel, the reagent test region coefficient of variation (Cv_{TR}) to the determined dynamic coefficient of variation limit (Cv_{TR, lim}) for the reagent test region;
ix) if the reagent test region coefficient of variation (Cv_{TR}) is larger than the dynamic coefficient of variation limit (Cv_{TR, lim}), considering the optical test strip to be corrupted and aborting the measurement method; and
x) if the reagent test region coefficient of variation (Cv_{TR}) is smaller than the dynamic coefficient of variation limit (Cv_{TR, lim}), considering the optical test strip to be non-corrupted and determining a concentration of at least one analyte in the sample of bodily fluid by using, for the at least one color channel, at least one color formation value for a color formation of the reagent test region having at least one sample of at least one bodily fluid applied to the reagent test region of the optical test strip.

As outlined above, the determination method specifically may be performed under controlled conditions, e.g., by a manufacturer or a provider, using the training set of optical test strips and using the training set of mobile devices. The measurement method, on the other hand, may be performed by a user in the field, specifically by using his or her personal mobile device and one or more optical test strips. The personal mobile device, as an example, may be of a specific type being amongst the one or more types of mobile devices of the training set of mobile devices used in the determination method. The method, as an example, may make sure that this is the case, e.g., by checking if the personal mobile device of the user is listed in a list of admissible mobile devices. The method may even comprise aborting the measurement and/or may comprise providing a warning to the user method if this is not the case. Additionally or alternatively, the personal mobile device may be of a specific type not being amongst the one or more types of mobile devices of the training set of mobile devices used in the determination method. The method may still make sure that the personal mobile device is usable for reliable and accurate analytical measurements, e.g., by checking if the personal mobile device of the user is listed in a list of inadmissible mobile devices.

As said, in step ix), the optical test strip is considered to be corrupted if the reagent test region coefficient of variation (Cv_{TR}) is larger than the dynamic coefficient of variation limit (Cv_{TR, lim}). As further said, in step x), the optical test strip is considered to be non-corrupted if the reagent test region coefficient of variation (Cv_{TR}) is smaller than the dynamic coefficient of variation limit (Cv_{TR, lim}). Thus, if the reagent test region coefficient of variation (Cv_{TR}) is equal to the dynamic coefficient of variation limit (Cv_{TR, lim}), the optical test strip may be considered to be corrupted or the optical test strip may be considered to be non-corrupted, e.g., depending on a predefined default setting. In other words, the measurement method may comprise, if the reagent test region coefficient of variation (Cv_{TR}) is equal to the dynamic coefficient of variation limit (Cv_{TR, lim}), considering the optical test strip to be corrupted and aborting the measurement method, or, considering the optical test strip to be non-corrupted and determining a concentration of at least one analyte in the sample of bodily fluid by using, for the at least one color channel, at least one color formation value for a color formation of the reagent test region having at least one sample of at least one bodily fluid applied to the reagent test region of the optical test strip.

The measurement method may further comprise at least one step of applying the at least one sample of the at least one bodily fluid to the reagent test region of the optical test strip, wherein the measurement method may be performed according to one of the following ways:
the dynamic coefficient of variation limit (Cv_{TR, lim}) in step vi) is determined by using a relation derived when performing the determination method according to any one of the embodiments disclosed above or below in further detail referring to a determination method having at least one sample of the at least one bodily fluid applied to the reagent test regions of the optical test strips of the training set of optical test strips, wherein the measurement method comprises applying the sample of the bodily fluid to the reagent test region of the optical test strip before performing step iii); or
the dynamic coefficient of variation limit (Cv_{TR, lim}) in step vi) is determined by using a relation derived when performing the determination method according to any one of the embodiments disclosed above or below in further detail referring to a determination method having no sample of the at least one bodily fluid applied to the reagent test regions of the optical test strips of the training set of optical test strips, wherein the measurement method comprises performing steps iii) to viii) with no sample of the at least one bodily fluid applied to the reagent test region of the optical test strip, and wherein the method further comprises applying the at least one sample of the bodily fluid to the reagent test region of the optical test strip before or during performing step x).

Thus, the determination method may be performed with the sample of the bodily fluid applied to the reagent test region, e.g., as described in optional step g) of the determination method, and the measurement method may be performed by using a relation for determining the dynamic coefficient of variation limit (Cv_{TR, lim}) derived in the determination method. Alternatively, the determination method may be performed without the sample of the bodily fluid applied to the reagent test region and the measurement method may be performed by using a relation for determining the dynamic coefficient of variation limit (Cv_{TR, lim}) derived in the determination method, wherein, for determining a concentration of at least one analyte in the sample of the bodily fluid, the sample of the bodily fluid may be applied to the reagent test region after comparing a measured reagent test region coefficient of variation (Cv_{TR}) to the determined dynamic coefficient of variation limit (Cv_{TR, lim}). In such way, the measured reagent test region coefficient of variation (Cv_{TR}) may specifically only be compared to an adequate dynamic coefficient of variation limit (Cv_{TR, lim}). Thus, the measured reagent test region coefficient of variation (Cv_{TR}) of a reagent test region having a sample of bodily fluid applied thereto may only be compared to a dynamic coefficient of variation limit (Cv_{TR, lim}) derived by using reagent test regions having a sample of bodily fluid applied thereto. Further, the measured reagent test region coefficient of variation (Cv_{TR}) of a reagent test region having no sample of bodily fluid applied thereto may only be compared to a dynamic coefficient of variation limit (Cv_{TR, lim}) derived by using reagent test regions having no sample of bodily fluid applied thereto.

The measurement method may further comprise step xi) of attaching the optical test strip to the color reference card. Step xi) may be performed before step iii).

The measurement method may at least partially be computer-implemented, specifically at least one of steps iv) to x). Referring to the computer-implemented aspects of this disclosure, one or more of the method steps or even all of the method steps of the measurement method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

For further definitions and/or embodiments regarding the measurement method, reference may be made to the definitions and/or embodiments regarding the determination method.

In a further aspect of this disclosure, a determination system for determining a dynamic coefficient of variation limit (Cv_{TR, lim}) for assessing validity of an optical test strip usable for an analytical measurement based on a color formation reaction is disclosed. The determination system comprises:
A) a training set of optical test strips, each optical test strip having a reagent test region, wherein at least two of the optical test strips are non-corrupted and wherein at least two of the optical test strips are corrupted;
B) a training set of mobile devices, each mobile device having at least one camera;
C) at least one color reference card having a plurality of color reference fields having known reference color values;
D) at least one processor, the processor being configured for:
   retrieving a training set of images, the training set of images comprising images captured with the camera, wherein each image of the training set of images comprises at least a part of a reagent test region of an optical test strip of the training set of optical test strips and at least a part of at least one color reference field of the color reference card;
   determining, for at least one color channel of the cameras of the mobile devices of the training set of mobile devices, a training set of pairs of reagent test region coefficients of variation (Cv_{TR}) and corresponding minimum color reference field coefficients of variation (Cv_{RF, min}), wherein each reagent test region coefficient of variation (Cv_{TR}) is determined by measuring a color variation within the reagent test region, wherein each color reference field coefficient of variation (Cv_{RF}) is determined by measuring a color variation within the color reference field, wherein a minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields of which a common image was captured together with the corresponding reagent test region; and
   deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}), wherein the dynamic coefficient of variation limit (Cv_{TR, lim}) defines a maximum coefficient of variation (Cv_{TR, max}) for reagent test regions of non-corrupted optical test strips.

The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components or parts forming a whole. Specifically, the components may interact with each other in order to fulfill at least one common function. The at least two components may be handled independently or may be coupled or connectable. Consequently, the term “determination system” as used herein is a broad term and is to be given its ordinary and customary meaning to a person of ordinary skill in the art and is not to be limited to a special or customized meaning. The term specifically may refer, without limitation, to a system configured for performing at least one determination operation. The determination system may be configured for being used in the determination method according to any one of the embodiments disclosed above or below in further detail referring to a determination method, specifically for performing at least steps e) and f) of the determination method according to any one of the embodiments disclosed above or below in further detail referring to a determination method.

As said, the determination system may comprise at least one processor. The processor may be configured for being connected to the mobile devices of the training set of mobile devices and/or for reading out the mobile devices of the training set of mobile devices, specifically for retrieving the training set of images. A processing of the training set of images may at least partially be cloud based. Thus, the determination system or at least parts thereof, specifically the processor or at least parts thereof, may be cloud based. The term “cloud based” as used herein is a broad term and is to be given its ordinary and customary meaning to a person of ordinary skill in the art and is not to be limited to a special or customized meaning. The term specifically may refer, without limitation, to an outsourcing of a system or device or parts thereof to interconnected external devices, specifically computers or computer networks having larger computing power and/or data storage volume. The external devices may be arbitrarily spatially distributed. The external devices may vary over time, specifically on demand. The external devices may be interconnected, e.g., by using the internet. The external devices may each comprise at least one interface, such as a wireless interface and/or a wire-bound interface, specifically at least one communication interface. Thus, as an example, the processor may at least partially be comprised by one or more mobile devices, e.g., by one or more mobile devices of the training set of mobile device. However, the processor may also be a computer, e.g., a computer used in a laboratory. Other options are feasible.

For further definitions and/or embodiments regarding the determination system, reference may be made to the definitions and/or embodiments regarding the determination method and/or the measurement method.

In a further aspect of this disclosure, a computer program is disclosed, the computer program comprising instructions which, when the program is executed by a determination system, specifically by the determination system according to any one of the embodiments described above or below in further detail referring to a determination system, cause the determination system to carry out at least steps e) and f) of the determination method according to any one of the embodiments described above or below in further detail referring to a determination method.

The computer program may further comprise instructions which, when the program is executed by a determination system, specifically by the determination system according to any one of the embodiments described above or below in further detail referring to a determination system, control the performing of step d) of the determination method according to any one of the embodiments described above or below in further detail referring to a determination method. The computer program may further comprise instructions which, when the program is executed by a determination system, specifically by the determination system according to any one of the embodiments described above or below in further detail referring to a determination system, cause the determination system to prompt a user to perform steps a) to c) of the determination method according to any one of the embodiments described above or below in further detail referring to a determination method.

The computer program may also be embodied as a computer program product. As used herein, a computer program product may refer to the program as a tradable product. The product may generally exist in an arbitrary format, such as in a paper format, or on a computer-readable data carrier and/or on a computer-readable storage medium. Specifically, the computer program product may be distributed over a data network.

In a further aspect of this disclosure, a computer-readable storage medium is disclosed, the computer-readable storage medium comprising instructions which, when executed by a determination system, specifically by the system according to any one of the embodiments described above or below in further detail referring to a determination system, cause the determination system to carry out at least steps e) and f) of the determination method according to any one of the embodiments described above or below in further detail referring to a determination method.

The term “computer-readable storage medium” as used herein is a broad term and is to be given its ordinary and customary meaning to a person of ordinary skill in the art and is not to be limited to a special or customized meaning. The term specifically may refer, without limitation, to a non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM) and/or a flash memory.

The computer-readable storage medium may further comprise instructions which, when executed by a determination system, specifically by the determination system according to any one of the embodiments described above or below in further detail referring to a determination system, control the performing of step d) of the determination method according to any one of the embodiments described above or below in further detail referring to a determination method. The computer-readable storage medium may further comprise instructions which, when executed by a determination system, specifically by the determination system according to any one of the embodiments described above or below in further detail referring to a determination system, cause the determination system to prompt a user to perform steps a) to c) of the determination method according to any one of the embodiments described above or below in further detail referring to a determination method.

In a further aspect of this disclosure, a mobile device having at least one camera and at least one processor is disclosed, the mobile device being configured for performing at least steps iv) to x) of the measurement method according to any one of the embodiments described above or below in further detail referring to a measurement method.

For further definitions and/or embodiments regarding the mobile device, reference may be made to the definitions and/or embodiments regarding the determination method and/or the measurement method and/or the determination system.

In a further aspect of this disclosure, a computer program is disclosed, the computer program comprising instructions which, when the program is executed by a mobile device having a camera and a processor, specifically by a mobile device according to any one of the embodiments described above or below in further detail referring to a mobile device, cause the mobile device to carry out at least steps iv) to x) of the measurement method according to any one of the embodiments described above or below in further detail referring to a measurement method.

The computer program may further comprise instructions which, when the program is executed by a mobile device, specifically by the mobile device according to any one of the embodiments described above or below in further detail referring to a mobile device, control the performing of step iii) of the measurement method according to any one of the embodiments described above or below in further detail referring to a measurement method. The computer program may further comprise instructions which, when the program is executed by a mobile device, specifically by the mobile device according to any one of the embodiments described above or below in further detail referring to a mobile device, cause the mobile device to prompt a user to perform steps i) and ii) of the measurement method according to any one of the embodiments described above or below in further detail referring to a measurement method.

The computer program may also be embodied as a computer program product. As used herein, a computer program product may refer to the program as a tradable product. The product may generally exist in an arbitrary format, such as in a paper format, or on a computer-readable data carrier and/or on a computer-readable storage medium. Specifically, the computer program product may be distributed over a data network.

In a further aspect of this disclosure, a computer-readable storage medium is disclosed, the computer-readable storage medium comprising instructions which, when executed by a mobile device having a camera and a processor, specifically by a mobile device according to any one of the embodiments described above or below in further detail referring to a mobile device, cause the mobile device to carry out at least steps iv) to x) of the measurement method according to any one of the embodiments described above or below in further detail referring to a measurement method.

The computer-readable storage medium may further comprise instructions which, when executed by a mobile device, specifically by the mobile device according to any one of the embodiments described above or below in further detail referring to a mobile device, control the performing of step iii) of the measurement method according to any one of the embodiments described above or below in further detail referring to a measurement method. The computer-readable storage medium may further comprise instructions which, when executed by a mobile device, specifically by the mobile device according to any one of the embodiments described above or below in further detail referring to a mobile device, cause the mobile device to prompt a user to perform steps i) and ii) of the measurement method according to any one of the embodiments described above or below in further detail referring to a measurement method.

The methods and devices according to this disclosure provide a large number of advantages over similar methods and devices known in the art. First of all, the methods and devices described herein may be particularly user-friendly, since they may allow a user to perform an analytical measurement, e.g., a blood glucose measurement, by using a mobile device, e.g., a personal smart phone or tablet. Moreover, the methods and devices described herein may specifically facilitate accurate and reliable analytical measurements when using such mobile devices. Thus, the methods and devices described herein may generally increase measurement safety, specifically by providing an effective fail safe mechanism, specifically for identifying corrupted optical test strips. Corrupted optical test strips, such as optical test strips which have already been used, may lead to false and misleading results of analytical measurements. This may be prevented by using the proposed methods and devices. Specifically, the methods and devices described herein may comprise preventing a determination of a concentration of an analyte in a bodily fluid if an optical test strip used for this purpose is identified as being corrupted. Specifically with respect to blood glucose measurements or similar health related analytical measurements, this may prevent severe health damages and potentially be lifesaving.

The methods and devices described herein may further be widely applicable, e.g., for a variety of different mobile devices such as different smart phones having different cameras. The methods and devices may further consider varying environmental conditions, e.g., a varying illumination when taking an image. Thus, the proposed methods and devices may specifically be individually applicable for each analytical measurement. Specifically, they may allow an individual reliability and safety assessment for each analytical measurement. Further, the proposed methods and devices may allow for an improved user handling and improved user friendliness of analytical measurements by allowing a safe analytical measurement to be performed by only capturing one image, instead of capturing at least two images. Specifically, the overall time necessary for performing the analytical measurement may be decreased compared to known methods and devices. Further, the proposed methods and devices may reduce requirements on a user regarding performing an analytical measurement, which may specifically be significant with respect to users in poor health or elderly users.

Summarizing and without excluding further possible embodiments, the following embodiments may be envisaged:

Embodiment 1: A determination method of determining a dynamic coefficient of variation limit (Cv_{TR, lim}) for assessing validity of an optical test strip usable for an analytical measurement based on a color formation reaction, the method comprising:
a) providing a training set of optical test strips, each optical test strip having a reagent test region, wherein at least two of the optical test strips are non-corrupted and wherein at least two of the optical test strips are corrupted;
b) providing a training set of mobile devices, each mobile device having at least one camera;
c) providing at least one color reference card having a plurality of color reference fields having known reference color values;
d) capturing, by using the mobile devices of the training set of mobile devices, a training set of images, wherein each image of the training set of images comprises at least a part of at least one reagent test region of an optical test strip of the training set of optical test strips and at least a part of at least one color reference field of the color reference card;
e) determining, specifically by using at least one processor, more specifically at least one processor of the mobile device, for at least one color channel of the cameras of the mobile devices of the training set of mobile devices, a training set of pairs of reagent test region coefficients of variation (Cv_{TR}) and corresponding minimum color reference field coefficients of variation (Cv_{RF, min}), wherein each reagent test region coefficient of variation (Cv_{TR}) is determined by measuring a color variation within the reagent test region, wherein each color reference field coefficient of variation (Cv_{RF}) is determined by measuring a color variation within the color reference field, wherein a minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields of which a common image was captured together with the corresponding reagent test region; and
f) deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}), wherein the dynamic coefficient of variation limit (Cv_{TR, lim}) defines a maximum coefficient of variation (Cv_{TR, max}) for reagent test regions of non-corrupted optical test strips.

Embodiment 2: The determination method according to the preceding embodiment, wherein the method further comprises step g) of applying a sample of bodily fluid to the reagent test region of the optical test strip, wherein step g) specifically is performed before step d).

Embodiment 3: The determination method according to any one of the preceding embodiments, wherein the method further comprises step h) of attaching at least one optical test strip of the training set of optical test strips to the color reference card comprising a plurality of color reference fields having known reference color values, wherein step h) is performed before step d) and optionally before step g).

Embodiment 4: The determination method according to any one of the preceding embodiments, wherein the corrupted optical test strip is corrupted by at least one of: a previous appliance of a fluid sample, specifically a sample of bodily fluid; a previous exposure to at least one corruptive environment for more than 10 minutes, specifically for more than 2 hours, more specifically for more than 1 day; a time elapsed since application of a fluid sample being out of a tolerance range, specifically a time between sample application and capturing of an image.

Embodiment 5: The determination method according to the preceding embodiment, wherein the corruptive environment is selected from the group consisting of: a humid environment, specifically an environment having a humidity of more than 60%, more specifically a humidity of more than 80%, and a bright environment, specifically an environment having an illuminance of more than 1000 lm/m², more specifically an illuminance of more than 1500 lm/m².

Embodiment 6: The determination method according to any one of the preceding embodiments, wherein step e) further comprises labelling the pairs of reagent test region coefficients of variation (Cv_{TR}) and corresponding minimum color reference field coefficients of variation (Cv_{RF, min}) of the training set of pairs of reagent test region coefficients of variation (Cv_{TR}) and corresponding minimum color reference field coefficients of variation (Cv_{RF, min}) with information on whether the respective optical test strip of the training set of optical test strips was corrupted or non-corrupted, wherein the labelling specifically is taken into consideration in step f).

Embodiment 7: The determination method according to any one of the preceding embodiments, wherein in step f) the dynamic coefficient of variation limit (Cv_{TR, lim}) excludes at least 90%, specifically at least 95%, more specifically at least 99%, of the corrupted optical test strips of the training set of optical test strips.

Embodiment 8: The determination method according to any one of the preceding embodiments, wherein in step f) the dynamic coefficient of variation limit (Cv_{TR, lim}) permits acceptance of at least 80%, specifically at least 90%, more specifically at least 95%, more specifically at least 97%, more specifically at least 99%, of the non-corrupted optical test strips of the training set of optical test strips.

Embodiment 9: The determination method according to any one of the preceding embodiments, wherein the relation derived in step f) comprises at least one of a look-up table, a model, an algorithm and a function.

Embodiment 10: The determination method according to according to any one of the preceding embodiments, wherein the relation derived in step f) comprises a function, wherein the function is a linear function.

Embodiment 11: The determination method according to the preceding embodiment, wherein the linear function has a slope of 1.

Embodiment 12: The determination method according to any one of the preceding embodiments, wherein the dynamic coefficient of variation limit (Cv_{TR, lim}) comprises a predefined maximum coefficient of variation limit (Cv_{TR, max, predefined}) for reagent test regions which is not exceedable.

Embodiment 13: The determination method according to any one of the preceding embodiments, wherein step f) comprises using at least one machine-learning algorithm, specifically by training a trainable model by using the training set of pairs of reagent test region coefficients of variation (Cv_{TR}) and corresponding minimum color reference field coefficients of variation (Cv_{RF, min}).

Embodiment 14: The determination method according to any one of the preceding embodiments, wherein in step e) the pairs of reagent test region coefficients of variation (Cv_{TR}) and corresponding minimum color reference field coefficients of variation (Cv_{RF, min}) are determined for at least two color channels, specifically for at least two color channels selected from the group consisting of: a green color channel, a blue color channel and a red color channel.

Embodiment 15: The determination method according to the preceding embodiment, wherein in step f) the dynamic coefficient of variation limit (Cv_{TR, lim}) is derived for the at least two color channels for which the pairs of reagent test region coefficients of variation (Cv_{TR}) and corresponding minimum color reference field coefficients of variation (Cv_{RF, min}) are determined in step e).

Embodiment 16: A measurement method of performing an analytical measurement based on a color formation reaction by using a mobile device having a camera and a processor, the method comprising:
i) providing at least one optical test strip having at least one reagent test region, wherein the optical test strip specifically is of the same type of optical test strips as the optical test strips of the training set used in step a) of the determination method according to any one of the preceding embodiments;
ii) providing at least one color reference card having a plurality of color reference fields having known reference color values;
iii) capturing, by using the camera, at least one image of at least a part of the reagent test region having at least one sample of at least one bodily fluid applied thereto and at least a part of at least one of the color reference fields of the color reference card;
iv) determining, specifically by using the processor, for at least one color channel of the camera of the mobile device, a color reference field coefficient of variation (Cv_{RF}) for at least one of the color reference fields by using the image, wherein the color reference field coefficient of variation (Cv_{RF}) is determined by measuring a color variation within the at least one color reference field;
v) determining, specifically by using the processor, a minimum color reference field coefficient of variation (Cv_{RF, min}) for the color reference card by using the at least one color reference field coefficient of variation (Cv_{RF}) determined in step iv);
vi) determining, specifically by using the processor, a dynamic coefficient of variation limit (Cv_{TR, lim}) for the reagent test region by using the minimum color reference field coefficient of variation (Cv_{RF, min}) determined in step v) and by using a relation for determining the dynamic coefficient of variation limit (Cv_{TR, lim}), wherein the relation is determined by performing the determination method according to any one of the preceding embodiments;
vii) determining, specifically by using the processor, for the at least one color channel, a reagent test region coefficient of variation (Cv_{TR}) of the reagent test region by using the image, wherein the reagent test region coefficient of variation (Cv_{TR}) is determined by measuring a color variation within the reagent test region;
viii) comparing, for the at least one color channel, the reagent test region coefficient of variation (Cv_{TR}) to the determined dynamic coefficient of variation limit (Cv_{TR}, him) for the reagent test region;
ix) if the reagent test region coefficient of variation (Cv_{TR}) is larger than the dynamic coefficient of variation limit (Cv_{TR, lim}), considering the optical test strip to be corrupted and aborting the measurement method; and
x) if the reagent test region coefficient of variation (Cv_{TR}) is smaller than the dynamic coefficient of variation limit (Cv_{TR, lim}), considering the optical test strip to be non-corrupted and determining a concentration of at least one analyte in the sample of bodily fluid by using, for the at least one color channel, at least one color formation value for a color formation of the reagent test region having at least one sample of at least one bodily fluid applied to the reagent test region of the optical test strip.

Embodiment 17: The measurement method according to the preceding embodiment, further comprising at least one step of applying the at least one sample of the at least one bodily fluid to the reagent test region of the optical test strip, wherein the measurement method is performed according to one of the following ways:
the dynamic coefficient of variation limit (Cv_{TR, lim}) in step vi) is determined by using a relation derived when performing the determination method according to any one of the preceding embodiments referring to a determination method having at least one sample of the at least one bodily fluid applied to the reagent test regions of the optical test strips of the training set of optical test strips, wherein the measurement method comprises applying the sample of the bodily fluid to the reagent test region of the optical test strip before performing step iii); or
the dynamic coefficient of variation limit (Cv_{TR, lim}) in step vi) is determined by using a relation derived when performing the determination method according to any one of the preceding embodiments referring to a determination method having no sample of the at least one bodily fluid applied to the reagent test regions of the optical test strips of the training set of optical test strips, wherein the measurement method comprises performing steps iii) to viii) with no sample of the at least one bodily fluid applied to the reagent test region of the optical test strip, and wherein the method further comprises applying the at least one sample of the bodily fluid to the reagent test region of the optical test strip before or during performing step x).

Embodiment 18: The measurement method according to any one of the preceding embodiments referring to a measurement method, wherein the measurement method further comprises step xi) of attaching the optical test strip to the color reference card, wherein step xi) is performed before step iii).

Embodiment 19: A determination system for determining a dynamic coefficient of variation limit (Cv_{TR, lim}) for assessing validity of an optical test strip usable for an analytical measurement based on a color formation reaction, comprising:
A) a training set of optical test strips, each optical test strip having a reagent test region, wherein at least two of the optical test strips are non-corrupted and wherein at least two of the optical test strips are corrupted;
B) a training set of mobile devices, each mobile device having at least one camera;
C) at least one color reference card having a plurality of color reference fields having known reference color values;
D) at least one processor, the processor being configured for:
   retrieving a training set of images, the training set of images comprising images captured with the camera, wherein each image of the training set of images comprises at least a part of a reagent test region of an optical test strip of the training set of optical test strips and at least a part of at least one color reference field of the color reference card;
   determining, for at least one color channel of the cameras of the mobile devices of the training set of mobile devices, a training set of pairs of reagent test region coefficients of variation (Cv_{TR}) and corresponding minimum color reference field coefficients of variation (Cv_{RF, min}), wherein each reagent test region coefficient of variation (Cv_{TR}) is determined by measuring a color variation within the reagent test region, wherein each color reference field coefficient of variation (Cv_{RF}) is determined by measuring a color variation within the color reference field, wherein a minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields of which a common image was captured together with the corresponding reagent test region; and
   deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}), wherein the dynamic coefficient of variation limit (Cv_{TR, lim}) defines a maximum coefficient of variation (Cv_{TR, max}) for reagent test regions of non-corrupted optical test strips.

Embodiment 20: The determination system according to the preceding embodiment, wherein the determination system is configured for being used in the determination method according to any one of the preceding embodiments referring to a determination method, specifically for performing at least steps e) and f) of the determination method according to any one of the preceding embodiments referring to a determination method.

Embodiment 21: A computer program comprising instructions which, when the program is executed by a determination system, specifically by the determination system according to any one of the preceding embodiments referring to a determination system, cause the determination system to carry out at least steps e) and f) of the determination method according to any one of the preceding embodiments referring to a determination method.

Embodiment 22: A computer-readable storage medium comprising instructions which, when executed by a determination system, specifically by the system according to any one of the preceding embodiments referring to a determination system, cause the determination system to carry out at least steps e) and f) of the determination method according to any one of the preceding embodiments referring to a determination method.

Embodiment 23: A mobile device having at least one camera and at least one processor, the mobile device being configured for performing at least steps iv) to x) of the measurement method according to any one of the preceding embodiments referring to a measurement method.

Embodiment 24: A computer program comprising instructions which, when the program is executed by a mobile device having a camera and a processor, specifically by a mobile device according to the preceding embodiment, cause the mobile device to carry out at least steps iv) to x) of the measurement method according to any one of the preceding embodiments referring to a measurement method.

Embodiment 25: A computer-readable storage medium comprising instructions which, when executed by a mobile device having a camera and a processor, specifically by a mobile device according to any one of the preceding embodiments referring to a mobile device, cause the mobile device to carry out at least steps iv) to x) of the measurement method according to any one of the preceding embodiments referring to a measurement method.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 schematically shows an exemplary embodiment of a determination system according to this disclosure;

FIG. 2 schematically shows an exemplary embodiment of a mobile device;

FIG. 3 shows a flow chart of an embodiment of a determination method;

FIG. 4 shows experimental data referring to an embodiment of a determination method;

FIG. 5 shows a flow chart of an embodiment of a measurement method; and

FIG. 6 shows experimental data referring to an embodiment of a measurement method.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

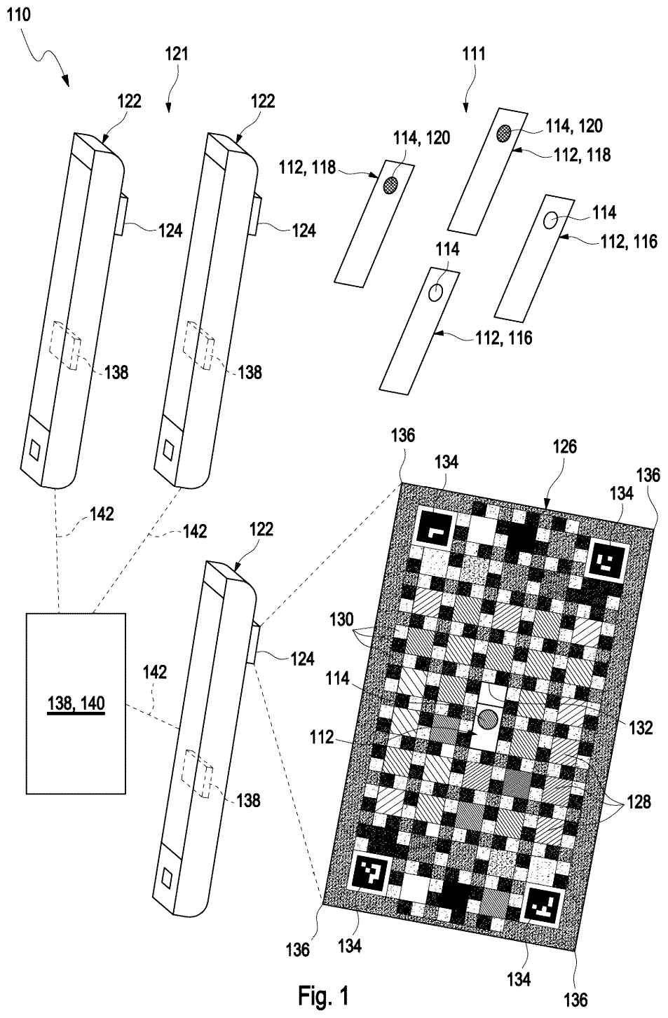

FIG. 1 schematically shows an exemplary embodiment of a determination system 110 for determining a dynamic coefficient of variation limit (Cv_{TR, lim}) for assessing validity of an optical test strip 112 usable for an analytical measurement based on a color formation reaction. The determination system 110 comprises a training set 111 of optical test strips 112. Each optical test strip 112 has a reagent test region 114. At least two of the optical test strips 112 are non-corrupted. At least two of the optical test strips 112 are corrupted. FIG. 1 exemplarily shows two non-corrupted optical test strips 116 and two corrupted optical test strips 118. In principle, the training set 111 of optical test strips 112 may specifically comprise an even larger number of optical test strips 112, specifically for better statistics. FIG. 1 exemplarily indicates a grid pattern 120 in the reagent test region 114 of the corrupted optical test strips 118. Typically, applied blood produces such a grid pattern 120 in the reagent test region 114 if there already has been blood applied on the reagent test region 114 previously, which increases an inhomogeneity of the reagent test region 114. In other words, the grid pattern 120 typically shows up, when a previously used optical test strip 112 is used again. Thus, the grid pattern 120 typically indicates a previous use corrupting the optical test strip 112. However, other options are also conceivable. As an example, the grid pattern 120 may also be a result of an intense light exposure which may also corrupt the optical test strip 112.

Generally, the corrupted optical test strip 118 may be corrupted by at least one of: a previous appliance of a fluid sample, specifically a sample of bodily fluid; a previous exposure to at least one corruptive environment for more than 10 minutes, specifically for more than 2 hours, more specifically for more than 1 day; a time elapsed since application of a fluid sample being out of a tolerance range, specifically a time between sample application and capturing of an image. The corruptive environment may be selected from the group consisting of: a humid environment, specifically an environment having a humidity of more than 60%, more specifically a humidity of more than 80%, and a bright environment, specifically an environment having an illuminance of more than 1000 lm/m², more specifically an illuminance of more than 1500 lm/m².

The determination system 110 further comprises a training set 121 of mobile devices 122. Each mobile device 122 has at least one camera 124. In principle, the training set 121 of mobile devices 122 may specifically comprise an even larger number of mobile devices 122, specifically for better statistics. The mobile device 122 may be or may comprise at least one of a cell phone, a smart phone, a tablet computer or the like. The camera 124 of the mobile device 128 may be configured for recording images, specifically color images. Thus, the camera 130 may be a color camera and may comprise at least three color sensors, such as at least one color sensor for the R, G, B colors.

The determination system 110 further comprises at least one color reference card 126. The color reference card 126 has a plurality of color reference fields 128. The color reference fields 128 have known reference color values. The color reference fields 128 may be arranged on a surface of the color reference card 126, such as on a substrate of the color reference card 126. In particular, the color reference fields 112 may be distributed equally over the surface of the color reference card 126, specifically in such a way that the plurality of color reference fields 126 may be distributed over the entire surface of the color reference card 126. As an example, the color reference fields 128 may be arranged in matrix pattern, such as a rectangular matrix pattern. However, the color reference fields 128 may also be arranged in other ways, such as separately from each other. For example, the color reference card 126 may comprise a plurality of gray color reference fields 130 surrounding the color reference fields 128. The color reference fields 128 and the gray color reference fields 130 may not overlap each other. In an exemplary embodiment of the color reference card 126, the color reference fields 128 and the gray color reference fields 130 may be printed on a pre-printed gray colored background of the color reference card 126. Thus, the color reference fields 128 may overlap with the gray colored background of the color reference card 126.

The color reference card 126 may further comprise at least one window 132. Thus, at least one optical test strip 112 or a part thereof may be visible through the window 132 when the color reference card 126 is placed on top of the optical test strip 112. Specifically, at least one reagent test region 114 comprised by the optical test strip 112 may be visible through the window 132 of the color reference card 126. As another example, the color reference card 126 may comprise an optical test strip 112 having a reagent test region 114, specifically in such a way that the reagent test region 112 is accessible and visible. Specifically, the optical test strip 112 may be attached to the color reference card 126 in such a way that the reagent test region 114 is accessible and visible. In such way, the color reference card 126 and the reagent test region 114 may both be in a field of view of a mobile device 122 for capturing an image comprising at least a part of the reagent test region 114 and at least a part of at least one color reference field 128 of the color reference card 126.

Further, the color reference card 126 may comprise at least one marker 134. The marker 134 may be or may, as an example, comprise at least one of a position marker, such as an ArUco code, a barcode, a QR-code, a label or a combination thereof. The marker 134 may be arranged in at least one corner 136 of the color reference card 126. For example, at least one marker 134 may be arranged in each of the corners 136 of the color reference card 126, specifically in such a way that the marker 134 may be visible together with the plurality of color reference fields 128. Further, the marker 134 may comprise information about an orientation of the color reference card 126. For further details relating to the color reference card 126, reference may also be made to international publication number WO 2021/228730 A1.

The determination system 110 further comprises at least one processor 138. As an example, the at least one processor 138 may at least partially be comprised by at least one computer 140. Additionally or alternatively, the at least one processor 138 may at least partially be comprised by at least one mobile device 122. The at least one processor 138 may be cloud based. Thus, the at least one processor 138 may, as an example, be distributed over at least one computer 140 and/or at least one mobile device 122. The at least one computer 140 and/or the at least one mobile device may at least partially be interconnected, such as by at least one connection 142. The at least one connection 142 may be wire bound and/or wireless. As an example, the at least one computer 140 may be designated for evaluating images captured by the mobile devices 122. Thus, as an example, the at least one computer 140 may be connected to the mobile devices 122 by connections 142, specifically for retrieving images from the mobile devices 122. The processor 138, specifically when at least partially comprised by at least one mobile device 122, may be configured for supporting capturing of at least one image. As an example, the processor 138 may prompt a user of the mobile device 122 to capture the image. Additionally or alternatively, the processor 138 may be configured for automatically capturing the image, e.g., when a reagent test region 114 and/or the color reference card 126 may be in a field of view.

The processor 138 is configured for retrieving a training set of images. The training set of images comprises images captured with the camera 124. Each image of the training set of images comprises at least a part of a reagent test region 114 of an optical test strip 112 of the training set of optical test strips 112 and at least a part of at least one color reference field 128 of the color reference card 126. Specifically, as indicated in FIG. 1, an image of an entire color reference card 126 having an optical test strip 112 attached such that a reagent test region 114 of the optical test strip 112 is visible through a window 132 of the color reference card 126 may be captured by using a mobile device 122. Thus, each image of the training set of images may specifically comprise an entire a reagent test region 114 and an entire color reference card 126.

The processor 138 is further configured for determining, for at least one color channel of the cameras 124 of the mobile devices 122 of the training set 121 of mobile devices 122, a training set of pairs of reagent test region coefficients of variation (Cv_{TR}) and corresponding minimum color reference field coefficients of variation (Cv_{RF, min}). Each reagent test region coefficient of variation (Cv_{TR}) is determined by measuring a color variation within the reagent test region 114. Each color reference field coefficient of variation (Cv_{RF}) is determined by measuring a color variation within the color reference field 128. A minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields 128 of which a common image was captured together with the corresponding reagent test region 114. Specifically, as indicated in FIG. 1, an image of an entire color reference card 126 having an optical test strip 112 attached such that a reagent test region 114 of the optical test strip 112 is visible through a window 132 of the color reference card 126 may be captured by using a mobile device 122. In this case, a minimum color reference field coefficient of variation (Cv_{RF, min}) may specifically be determined for the entire color reference card 126.

The processor 138 is further configured for deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}). The dynamic coefficient of variation limit (Cv_{TR, lim}) defines a maximum coefficient of variation (Cv_{TR, max}) for reagent test regions 114 of non-corrupted optical test strips 116. The determination system 110 may specifically be configured for being used in the determination method according to any one of the embodiments disclosed above or below in further detail referring to a determination method, specifically for performing at least steps e) and f) of the determination method according to any one of the embodiments disclosed above or below in further detail referring to a determination method.

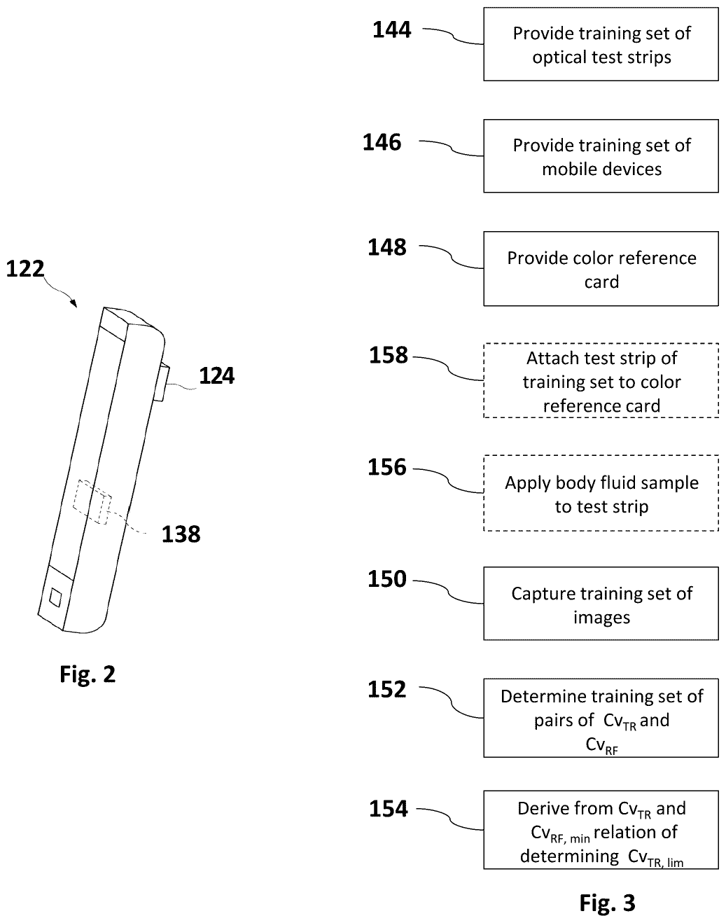

FIG. 2 schematically shows an exemplary embodiment of a mobile device 122 as proposed herein. The mobile devices 122 has at least one processor 138. The mobile device 122 is configured for performing at least steps iv) to x) of the measurement method according to any one of the embodiments disclosed above or below in further detail referring to a measurement method. The mobile device 122 for performing the measurement method typically is not identical to any one of the mobile devices 122 of the training set of mobile devices of the determination system 110. However, the mobile device 122 for performing the measurement, such as the mobile device 122 depicted in FIG. 2, may, as an example, be of the same type as at least one of the mobile devices 122 of the training set 121 of mobile devices 122 depicted in FIG. 1. The mobile device 122 depicted in FIG. 2 may, however, also be identical to one of the mobile devices 122 of the training set 121 of mobile devices 122 depicted in FIG. 1. Additionally or alternatively, the mobile device 122 depicted in FIG. 2 may be of a specific type not being amongst the one or more types of mobile devices 122 of the training set 121 of mobile devices 122 depicted in FIG. 1.

FIG. 3 shows a flow chart of an embodiment of a determination method of determining a dynamic coefficient of variation limit (Cv_{TR, lim}) for assessing validity of an optical test strip 112 usable for an analytical measurement based on a color formation reaction. The determination method comprises the following steps which, as an example, may be performed in the given order. It shall be noted, however, that a different order may generally also be possible. Further, it may also be possible to perform one or more of the method steps once or repeatedly. Further, it may be possible to perform two or more of the method steps simultaneously or in a timely overlapping fashion. The determination method may comprise further method steps which are not listed.

The determination method comprises:
a) (denoted with reference number 144) providing a training set 111 of optical test strips 112, each optical test strip 112 having a reagent test region 114, wherein at least two of the optical test strips 112 are non-corrupted and wherein at least two of the optical test strips 112 are corrupted;
b) (denoted with reference number 146) providing a training set 121 of mobile devices 122, each mobile device 122 having at least one camera 124;
c) (denote with reference sign 148) providing at least one color reference card 126 having a plurality of color reference fields 128 having known reference color values;
d) (denoted with reference number 150) capturing, by using the mobile devices 122 of the training set 121 of mobile devices 122, a training set of images, wherein each image of the training set of images comprises at least a part of at least one reagent test region 114 of an optical test strip 112 of the training set 111 of optical test strips 112 and at least a part of at least one color reference field 128 of the color reference card 126;
e) (denoted with reference number 152) determining, specifically by using at least one processor 138, more specifically at least one processor 138 of the mobile device 122, for at least one color channel of the cameras 124 of the mobile devices 122 of the training set 121 of mobile devices 122, a training set of pairs of reagent test region coefficients of variation (Cv_{TR}) and corresponding minimum color reference field coefficients of variation (Cv_{RF, min}), wherein each reagent test region coefficient of variation (Cv_{TR}) is determined by measuring a color variation within the reagent test region 114, wherein each color reference field coefficient of variation (Cv_{RF}) is determined by measuring a color variation within the color reference field 128, wherein a minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields 128 of which a common image was captured together with the corresponding reagent test region 114;
f) (denoted with reference number 154) deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region 114 by using the corresponding measured minimum color reference field coefficient of variation (Cv_{RF, min}), wherein the dynamic coefficient of variation limit (Cv_{TR, lim}) defines a maximum coefficient of variation (Cv_{TR, max}) for reagent test regions 113 of non-corrupted optical test strips 116.

The determination method may further comprise step g) (denoted with reference number 156) of applying a sample of bodily fluid to the reagent test region 114 of the optical test strip 112. Step g) may specifically be performed before step d). The determination method may further comprise step h) (denoted with reference number 158) of attaching at least one optical test strip 112 of the training set 111 of optical test strips 112 to the color reference card 126 comprising a plurality of color reference fields 128 having known reference color values. Step h) may be performed before step d) and optionally before step g).

Step e) may further comprise labelling the pairs of reagent test region coefficients of variation (Cv_{TR}) and corresponding minimum color reference field coefficients of variation (Cv_{RF, min}) of the training set of pairs of reagent test region coefficients of variation (Cv_{TR}) and corresponding minimum color reference field coefficients of variation (Cv_{RF, min}) with information on whether the respective optical test strip 112 of the training set 111 of optical test strips 112 was corrupted or non-corrupted. The labelling may specifically be taken into consideration in step f). In step f), the dynamic coefficient of variation limit (Cv_{TR, lim}) may exclude at least 90%, specifically at least 95%, more specifically at least 99%, of the corrupted optical test strips 118 of the training set 111 of optical test strips 112. In step f), the dynamic coefficient of variation limit (Cv_{TR, lim}) may permit acceptance of at least 80%, specifically at least 90%, more specifically at least 95%, more specifically at least 97%, more specifically at least 99%, of the non-corrupted optical test strips 116 of the training set 111 of optical test strips 112. In other words, in step f), the dynamic coefficient of variation limit (Cv_{TR, lim}) may not exclude more than 5%, specifically more than 3%, more specifically more than 1%, of the non-corrupted optical test strips 116 of the training set 111 of optical test strips 112. The relation derived in step f) may comprise at least one of a look-up table, a model, an algorithm and a function. The relation derived in step f) may comprise a function. The function may be a linear function. The linear function may have a slope of 1.

The dynamic coefficient of variation limit (Cv_{TR, lim}) may comprise a predefined maximum coefficient of variation limit (Cv_{TR, max, predefined}) for reagent test regions 114 which is not exceedable. Step f) may comprise using at least one machine-learning algorithm, specifically by training a trainable model by using the training set of pairs of reagent test region coefficients of variation (Cv_{TR}) and corresponding minimum color reference field coefficients of variation (Cv_{RF, min}). In step e), the pairs of reagent test region coefficients of variation (Cv_{TR}) and corresponding minimum color reference field coefficients of variation (Cv_{RF, min}) may be determined for at least two color channels, specifically for at least two color channels selected from the group consisting of: a green color channel, a blue color channel and a red color channel. In step f), the dynamic coefficient of variation limit (Cv_{TR, lim}) may be derived for the at least two color channels for which the pairs of reagent test region coefficients of variation (Cv_{TR}) and corresponding minimum color reference field coefficients of variation (Cv_{RF, min}) may be determined in step e). As an example, for each color channel an individual dynamic coefficient of variation limit (Cv_{TR, lim}) may at first be derived, wherein the individual dynamic coefficient of variation limits (Cv_{TR, lim}) may subsequently be compared with each other.

However, specifically, for each color channel, an individual dynamic coefficient of variation limit (Cv_{TR, lim}) may be derived, wherein, for each color channel, the reagent test region coefficient of variation (Cv_{TR}) may be compared to the individual dynamic coefficient of variation limit (Cv_{TR, lim}) of the color channel, wherein, for a non-corrupted optical test strip 116, the reagent test region coefficients of variation (Cv_{TR}) may have to be smaller than, or optionally equal to, the individual dynamic coefficient of variation limit (Cv_{TR, lim}) of the color channel for all color channels. In other words, for a corrupted optical test strip 118, the reagent test region coefficients of variation (Cv_{TR}) may have to be larger than, or optionally equal to, the individual dynamic coefficient of variation limit (Cv_{TR, lim}) of at least one color channel. As an example, the green color channel and the red color channel may be considered. Then, as an example, for a non-corrupted optical test strip 116, the coefficient of variation (Cv_{TR}) of the green color channel may have to be smaller than, or optionally equal to, the individual dynamic coefficient of variation limit (Cv_{TR, lim}) of the green color channel and the coefficient of variation (Cv_{TR}) of the red color channel may have to be smaller than, or optionally equal to, the individual dynamic coefficient of variation limit (Cv_{TR, lim}) of the red color channel. In other words, for a corrupted optical test strip 118, the coefficient of variation (Cv_{TR}) of the green color channel may have to be larger than, or optionally equal to, the individual dynamic coefficient of variation limit (Cv_{TR, lim}) of the green color channel or the coefficient of variation (Cv_{TR}) of the red color channel may have to be larger than, or optionally equal to, the individual dynamic coefficient of variation limit (Cv_{TR, lim}) of the red color channel. Further options are also feasible.

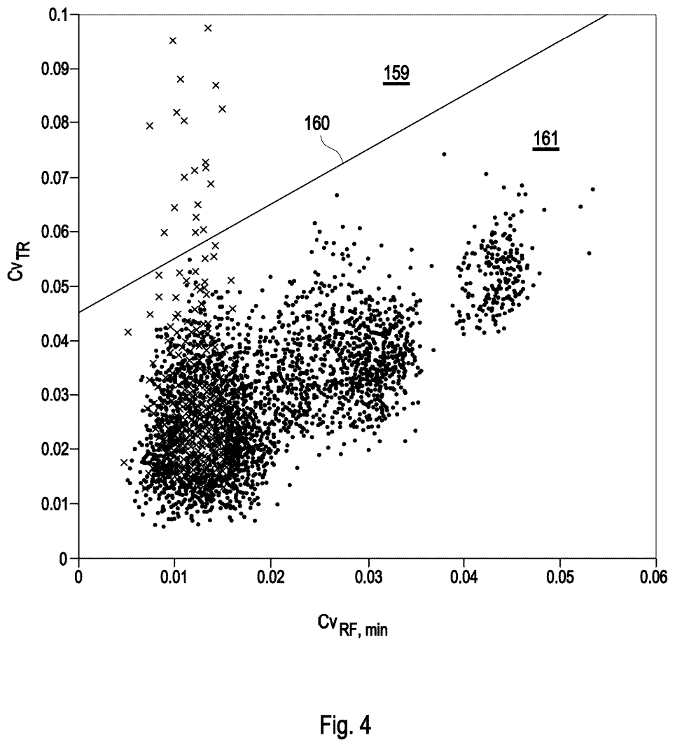

FIG. 4 shows experimental data referring to an embodiment of a determination method according to this disclosure. Specifically, FIG. 4 graphically illustrates pairs of reagent test region coefficients of variation (Cv_{TR}) and corresponding minimum color reference field coefficients of variation (Cv_{RF, min}) used for deriving a relation for determining the dynamic coefficient of variation limit (Cv_{TR, lim}) by using a measured minimum color reference field coefficient of variation (Cv_{RF, min}). As said, the relation may be a function, specifically a linear function, which is the case here. In FIG. 4, measured reagent test region coefficients of variation (Cv_{TR}) are plotted against measured corresponding minimum color reference field coefficients of variation (Cv_{RF, min}). Specifically, a color reference card 126 comprising 20 color reference field 128 was used for this purpose, wherein, by using different mobile devices 122 of a training set 121 of mobile devices 122, a training set of images was captured, each image comprising the entire color reference card 126 together with different reagent test regions 114 of different optical test strips 112 of a training set 111 of optical test strips 112. FIG. 4 specifically indicates three clouds of data points which may specifically, at least partially, refer to different mobile devices 122 of the training set 121 of mobile devices 122, more specifically to different types of mobile devices 122 of the training set 121 of mobile devices 122 such as different smart phones types. The optical test strips 112 used for the experiments shown in FIG. 4 were labelled as either corrupted or non-corrupted. Data referring to non-corrupted optical test strips 116 are indicated by dots in FIG. 4. Crosses indicate data referring to corrupted optical test strips 118 or to data referring to non-corrupted optical test strips 116 in FIG. 4. Specifically, the crosses may refer to so called provocation experiments which may comprise using non-corrupted optical test strips 116 or corrupted optical test strips 118. Thus, for one provocation experiment either a non-corrupted optical test strip 116 or a corrupted optical test strip 118 may be used. The provocation experiments may mainly use corrupted optical test strips 118. Specifically, at least 70% of the provocation experiments may use corrupted optical test strips 118, more specifically, at least 80% of the provocation experiments may use corrupted optical test strips 118, most specifically at least 90% of the provocation experiments may use corrupted optical test strips 118. Thus, at least some of the crosses shown in FIG. 4, specifically crosses below a derived dynamic coefficient of variation limit (Cv_{TR, lim}), may in fact refer to non-corrupted optical test strips 116. Based on this data, the following relation for the dynamic coefficient of variation limit (Cv_{TR, lim}) was derived:

$$C {v}_{TR , lim} = C {v}_{RF , min} + 0.045 .$$

The dynamic coefficient of variation limit (Cv_{TR, lim}) is plotted as geometrical line denoted with reference number 160 in FIG. 4. Further, a range above the geometrical line 160 is denoted with reference number 159 and a range below the geometrical line 160 is denoted with reference number 161 in FIG. 4. Thus, the dynamic coefficient of variation limit (Cv_{TR, lim}) in form of the geometrical line 160 separates the range 159 from the range 161. With respect to a later use for a measurement method of performing an analytical measurement, the range 159 may specifically refer to optical test strips 112 invalid for analytical measurements and the range 161 may specifically refer to optical test strips 112 valid for analytical measurements. As can be seen, the determined dynamic coefficient of variation limit (Cv_{TR, lim}) excludes a large extent of data points which may refer to corrupted optical test strips 118 (indicated by crosses in FIG. 4), while specifically allowing all data points which certainly refer to non-corrupted optical test strips 116 (indicated by dots in FIG. 4). Thus, the determined dynamic coefficient of variation limit (Cv_{TR, lim}) can be well used for identifying corrupted optical test strips 118 and for assessing validity of an optical test strip 112 for analytical measurements.

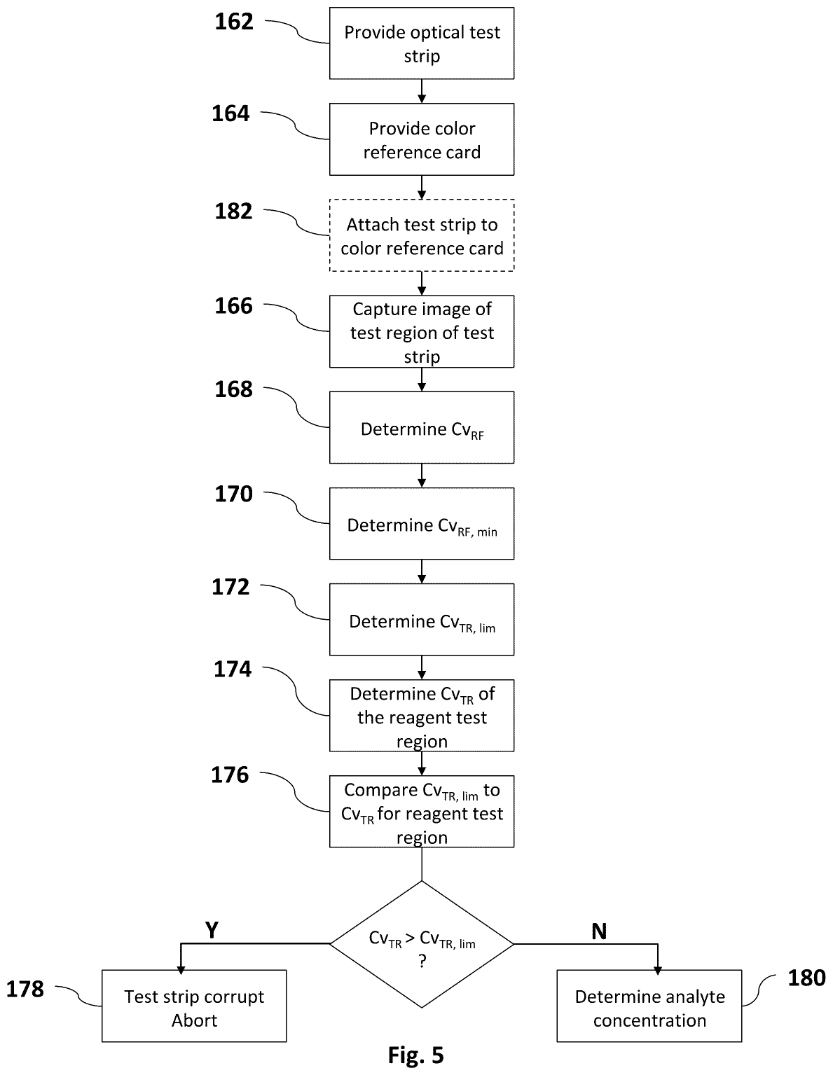

FIG. 5 shows a flow chart of an embodiment of a measurement of performing an analytical measurement based on a color formation reaction by using a mobile device 122 having a camera 124 and a processor 138. The measurement method comprises the following steps which, as an example, may be performed in the given order. It shall be noted, however, that a different order may generally also be possible. Further, it may also be possible to perform one or more of the method steps once or repeatedly. Further, it may be possible to perform two or more of the method steps simultaneously or in a timely overlapping fashion. The measurement method may comprise further method steps which are not listed.

The measurement method comprises:
i) (denoted with reference number 162) providing at least one optical test strip 112 having at least one reagent test region 114, wherein the optical test strip 112 specifically is of the same type of optical test strips 112 as the optical test strips 112 of the training set used in step a) of the determination method according to any one of the embodiments described above or below in further detail referring to a determination method;
ii) (denoted with reference number 164) providing at least one color reference card 126 having a plurality of color reference fields 128 having known reference color values;
iii) (denoted with reference number 166) capturing, by using the camera 124, at least one image of at least a part of the reagent test region 114 having at least one sample of at least one bodily fluid applied thereto and at least a part of at least one of the color reference fields 128 of the color reference card 126;
iv) (denoted with reference number 168) determining, specifically by using the processor 138, for at least one color channel of the camera 124 of the mobile device 122, a color reference field coefficient of variation (Cv_{RF}) for at least one of the color reference fields 128 by using the image, wherein the color reference field coefficient of variation (Cv_{RF}) is determined by measuring a color variation within the at least one color reference field 128;
v) (denoted with reference number 170) determining, specifically by using the processor 138, a minimum color reference field coefficient of variation (Cv_{RF, min}) for the color reference card 126 by using the at least one color reference field coefficient of variation (Cv_{RF}) determined in step iv);
vi) (denoted with reference number 172) determining, specifically by using the processor 138, a dynamic coefficient of variation limit (Cv_{TR, lim}) for the reagent test region 114 by using the minimum color reference field coefficient of variation (Cv_{RF, min}) determined in step v) and by using a relation for determining the dynamic coefficient of variation limit (Cv_{TR, lim}), wherein the relation is determined by performing the determination method according to any one of the embodiments described above or below in further detail referring to a determination method;
vii) (denoted with reference number 174) determining, specifically by using the processor 138, for the at least one color channel, a reagent test region coefficient of variation (Cv_{TR}) of the reagent test region 114 by using the image, wherein the reagent test region coefficient of variation (Cv_{TR}) is determined by measuring a color variation within the reagent test region 114;
viii) (denoted with reference number 176) comparing, for the at least one color channel, the reagent test region coefficient of variation (Cv_{TR}) to the determined dynamic coefficient of variation limit (Cv_{TR, lim}) for the reagent test region 114;
ix) (denoted with reference number 178) if the reagent test region coefficient of variation (Cv_{TR}) is larger than the dynamic coefficient of variation limit (Cv_{TR, lim}), considering the optical test strip 112 to be corrupted and aborting the measurement method; and
x) (denoted with reference number 180) if the reagent test region coefficient of variation (Cv_{TR}) is smaller than the dynamic coefficient of variation limit (Cv_{TR, lim}), considering the optical test strip 112 to be non-corrupted and determining a concentration of at least one analyte in the sample of bodily fluid by using, for the at least one color channel, at least one color formation value for a color formation of the reagent test region 114 having at least one sample of at least one bodily fluid applied to the reagent test region 114 of the optical test strip 112.

As indicated above in the context of the determination method, the dynamic coefficient of variation limit (Cv_{TR, lim}) separates possible reagent test region coefficients of variation (Cv_{TR}) into two possible cases: Firstly, the range 161 below the dynamic coefficient of variation limit (Cv_{TR, lim}) in FIG. 4, i.e., below the geometrical line 160, denoting optical test strips 112 validly usable for the measurement method of performing the analytical measurement and, secondly, the range 159 above the dynamic coefficient of variation limit (Cv_{TR, lim}) in FIG. 4, i.e., above the geometrical line 160, denoting optical test strips 112 not validly usable for the measurement method of performing the analytical measurement. The dynamic coefficient of variation limit (Cv_{TR, lim}) in FIG. 4, i.e., the geometrical line 160, itself, may be counted as being part of range 159, as being part of range 161, or none. Thus, generally, steps ix) and x) of the method as described imply checking in which of ranges 159 and 161 the test strip 112 intended for the actual run of the measurement method actually is located, thereby deciding if the test strip 112 actually may be validly used, e.g., being corrupted or not, and, depending on said decision, taking the appropriate further steps as listed in steps ix) and x).

The measurement method may further comprise at least one step of applying the at least one sample of the at least one bodily fluid to the reagent test region 114 of the optical test strip 112, wherein the measurement method is performed according to one of the following ways:
the dynamic coefficient of variation limit (Cv_{TR, lim}) in step vi) is determined by using a relation derived when performing the determination method according to any one of the embodiments disclosed above or below in further detail referring to a determination method having at least one sample of the at least one bodily fluid applied to the reagent test regions 114 of the optical test strips 112 of the training set 111 of optical test strips 112, wherein the measurement method comprises applying the sample of the bodily fluid to the reagent test region 114 of the optical test strip 112 before performing step iii); or
the dynamic coefficient of variation limit (Cv_{TR, lim}) in step vi) is determined by using a relation derived when performing the determination method according to any one of the embodiments disclosed above or below in further detail referring to a determination method having no sample of the at least one bodily fluid applied to the reagent test regions 114 of the optical test strips 112 of the training set 111 of optical test strips 112, wherein the measurement method comprises performing steps iii) to viii) with no sample of the at least one bodily fluid applied to the reagent test region 114 of the optical test strip 112, and wherein the method further comprises applying the at least one sample of the bodily fluid to the reagent test region 114 of the optical test strip 112 before or during performing step x).

The measurement method may further comprise step xi) (denoted by reference number 182) of attaching the optical test strip to the color reference card. Step xi) may be performed before step iii).

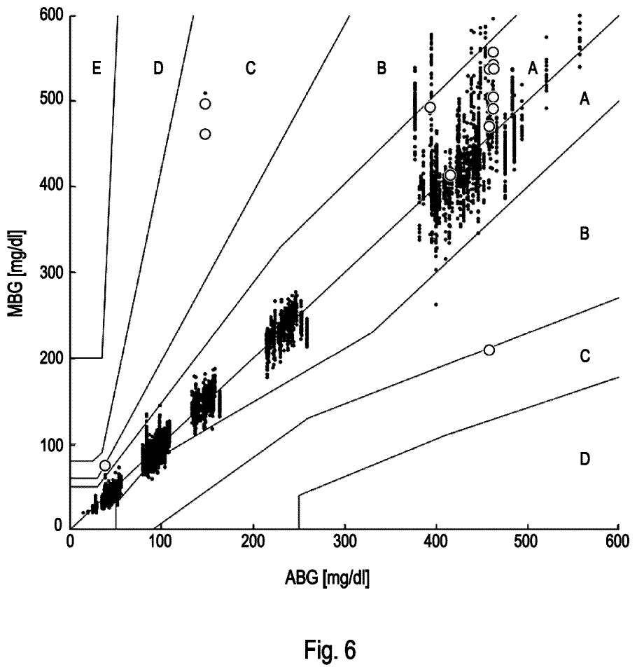

FIG. 6 shows experimental data referring to an embodiment of a measurement method according to this disclosure. Specifically, FIG. 6 show a consensus error grid, also referred to as Parkes error grid, which is a tool for evaluating an accuracy of blood glucose measurements. For further details regarding consensus error grids, reference may be made to Journal of Diabetes Science and Technology, Volume 7, Issue 5, September 2013 © Diabetes Technology Society, “Technical Aspects of the Parkes Error Grid,” Andreas Pfiitzner, M.D., Ph.D., David C. Klonoff, M.D., Scott Pardo, Ph.D., and Joan L. Parkes, Ph.D. FIG. 6 plots a measured blood glucose (MBG) level against an actual blood glucose (ABG) level of a user, wherein the blood glucose level was measured according to the measurement method of this disclosure. In simplified terms, the consensus error grid shows different standardized zones ranging from a practically non-critical zone A to a highly critical zone E for a user administering insulin depending on a measured blood glucose level. A large discrepancy between a measured blood glucose level and an actual blood glucose level may result in an unsuitable insulin administration and can thus be highly critical and even life threatening for the user. The consensus error grid comprises data obtained by using non-corrupted optical test strips 116 as well as corrupted optical test strips 118. The large circles plotted in the consensus error grid refer to data which could be detected by using a dynamic coefficient of variation limit (Cv_{TR, lim}) determined according to the above-derived function

$$C {v}_{TR , lim} = C {v}_{RF , min} + 0.045 .$$

Thus, specifically, a plurality of rather critical blood glucose measurements, e.g., in zone C, could be identified and the corresponding measurements could have been aborted in time. Contrarily, a static coefficient of variation limit of 0.09 would have detected only 1 data point.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this p pertains and which fall within the limits of the appended claims.

### LIST OF REFERENCE NUMBERS

110 determination system
111 training set of optical test strips
112 optical test strip
114 reagent test region
116 non-corrupted optical test strip
118 corrupted optical test strip
120 grid pattern
121 training set of mobile devices
122 mobile device
124 Camera
126 color reference card
128 color reference field
130 gray color reference field
132 Window
134 marker
136 Corner
138 Processor
140 Computer
142 Connection
144 determination method step a)
146 determination method step b)
148 determination method step c)
150 determination method step d)
152 determination method step e)
154 determination method step f)
156 determination method step g)
158 determination method step h)
159 range above geometrical line
160 geometrical line
161 range below geometrical line
162 measurement method step i)
164 measurement method step ii)
166 measurement method step iii)
168 measurement method step iv)
170 measurement method step v)
172 measurement method step vi)
174 measurement method step vii)
176 measurement method step viii)
178 measurement method step ix)
180 measurement method step x)
182 measurement method step xi)

What is claimed is:

1. A determination method of determining a dynamic coefficient of variation limit (Cv_{TR, lim}) for assessing validity of an optical test strip usable for an analytical measurement based on a color formation reaction, the method comprising:
a) providing a training set of optical test strips, each having a reagent test region, wherein at least two of the optical test strips are non-corrupted and at least two of the optical test strips are corrupted;
b) providing a training set of mobile devices, each mobile device having a camera;
c) providing a color reference card having a plurality of color reference fields with known reference color values;
d) capturing, by using the mobile devices of the training set of mobile devices, a training set of images, wherein each image of the training set of images comprises at least a part of at least one reagent test region of an optical test strip of the training set of optical test strips and at least a part of at least one color reference field of the color reference card;
e) determining, for at least one color channel of the cameras of the mobile devices of the training set of mobile devices, a training set of pairs of reagent test region coefficients of variation (Cv_{TR}) and corresponding minimum color reference field coefficients of variation (Cv_{RF, min}), wherein each reagent test region coefficient of variation (Cv_{TR}) is determined by measuring a color variation within the reagent test region, wherein each color reference field coefficient of variation (Cv_{RF}) is determined by measuring a color variation within the color reference field, wherein a minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields of which a common image was captured together with the corresponding reagent test region; and
f) deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}), wherein the dynamic coefficient of variation limit (Cv_{TR, lim}) defines a maximum coefficient of variation (Cv_{TR, max}) for reagent test regions of non-corrupted optical test strips.

2. The method according to claim 1, wherein the method further comprises step g) of applying a sample of body fluid to the reagent test region of the optical test strip.

3. The method according to claim 1, wherein the method further comprises step h) of attaching at least one of the optical test strips of the training set to the color reference card, wherein step h) is performed before step d).

4. The method according to claim 1, wherein one of the corrupted optical test strips is corrupted by at least one of: a previous appliance of a fluid sample; a previous exposure to at least one corruptive environment for more than 10 minutes; a time elapsed since application of a fluid sample being out of a tolerance range.

5. The method according to claim 4, wherein the corruptive environment is selected from the group consisting of a humid environment and a bright environment.

6. The method according to claim 1, wherein step e) further comprises labelling the pairs of reagent test region coefficients of variation (Cv_{TR}) and corresponding minimum color reference field coefficients of variation (Cv_{RF, min}) of the training set of pairs of reagent test region coefficients of variation (Cv_{TR}) and corresponding minimum color reference field coefficients of variation (Cv_{RF, min}) with information on whether the respective optical test strip of the training set of optical test strips was corrupted or non-corrupted.

7. The method according to claim 1, wherein in step f) the dynamic coefficient of variation limit (Cv_{TR, lim}) excludes at least 90% of the corrupted optical test strips of the training set of optical test strips.

8. The determination method according to claim 1, wherein in step f) the dynamic coefficient of variation limit (Cv_{TR, lim}) permits acceptance of at least 80% of the non-corrupted optical test strips of the training set of optical test strips.

9. The determination method according to claim 1, wherein the relation derived in step f) comprises a linear function.

10. A measurement method of performing an analytical measurement based on a color formation reaction by using a mobile device having a camera and a processor, the method comprising:
i) providing at least one optical test strip having at least one reagent test region;
ii) providing a color reference card having a plurality of color reference fields having known reference color values;
iii) capturing, by using the camera, an image of at least a part of the reagent test region having a sample of body fluid applied thereto and at least a part of at least one of the color reference fields of the color reference card;
iv) determining, for at least one color channel of the camera of the mobile device, a color reference field coefficient of variation (Cv_{RF}) for at least one of the color reference fields by using the image, wherein the color reference field coefficient of variation (Cv_{RF}) is determined by measuring a color variation within the at least one color reference field;
v) determining a minimum color reference field coefficient of variation (Cv_{RF, min}) for the color reference card by using the at least one color reference field coefficient of variation (Cv_{RF}) determined in step iv);
vi) determining a dynamic coefficient of variation limit (Cv_{TR, lim}) for the reagent test region by using the minimum color reference field coefficient of variation (Cv_{RF, min}) determined in step v) and by using a relation for determining the dynamic coefficient of variation limit (Cv_{TR, lim}), wherein the relation is determined by performing the determination method according to claim 1;
vii) determining, for the at least one color channel, a reagent test region coefficient of variation (Cv_{TR}) of the reagent test region by using the image, wherein the reagent test region coefficient of variation (Cv_{TR}) is determined by measuring a color variation within the reagent test region;
viii) comparing, for the at least one color channel, the reagent test region coefficient of variation (Cv_{TR}) to the determined dynamic coefficient of variation limit (Cv_{TR, lim}) for the reagent test region;
ix) when the reagent test region coefficient of variation (Cv_{TR}) is larger than the dynamic coefficient of variation limit (Cv_{TR, lim}), considering the optical test strip to be corrupted and aborting the measurement method; and
x) when the reagent test region coefficient of variation (Cv_{TR}) is smaller than the dynamic coefficient of variation limit (Cv_{TR, lim}), considering the optical test strip to be non-corrupted and determining a concentration of at least one analyte in the sample of body fluid by using, for the at least one color channel, at least one color formation value for a color formation of the reagent test region having at least one sample of at least one body fluid applied to the reagent test region of the optical test strip.

11. The measurement method according to claim 10, further comprising at least one step of applying the sample of body fluid to the reagent test region of the optical test strip, wherein the dynamic coefficient of variation limit (Cv_{TR, lim}) in step vi) is determined by using a relation derived with the sample of the body fluid applied to the reagent test regions of the optical test strips of the training set of optical test strips, wherein the measurement method comprises applying the sample of body fluid to the reagent test region before step iii).

12. The measurement method according to claim 10, further comprising at least one step of applying the sample of body fluid to the reagent test region of the optical test strip, wherein the dynamic coefficient of variation limit (Cv_{TR, lim}) in step vi) is determined by using a relation derived with no sample of the body fluid applied to the reagent test regions of the optical test strips of the training set of optical test strips, wherein the measurement method comprises performing steps iii) to viii) with no sample of the at least one body fluid applied to the reagent test region of the optical test strip, and wherein the method further comprises applying the at least one sample of the body fluid to the reagent test region of the optical test strip before or during performing step x).

13. A determination system for determining a dynamic coefficient of variation limit (Cv_{TR, lim}) for assessing validity of an optical test strip usable for an analytical measurement based on a color formation reaction, comprising:
A) a training set of optical test strips each having a reagent test region, wherein at least two of the optical test strips are non-corrupted and wherein at least two of the optical test strips are corrupted;
B) a training set of mobile devices, each mobile device having a camera;
C) a color reference card having a plurality of color reference fields having known reference color values;
D) a processor configured for:
retrieving a training set of images captured with the camera, wherein each image of the training set of images comprises at least a part of a reagent test region of an optical test strip of the training set of optical test strips and at least a part of at least one color reference field of the color reference card;
determining, for at least one color channel of the cameras of the mobile devices of the training set of mobile devices, a training set of pairs of reagent test region coefficients of variation (Cv_{TR}) and corresponding minimum color reference field coefficients of variation (Cv_{RF, min}), wherein each reagent test region coefficient of variation (Cv_{TR}) is determined by measuring a color variation within the reagent test region, wherein each color reference field coefficient of variation (Cv_{RF}) is determined by measuring a color variation within the color reference field, wherein a minimum color reference field coefficient of variation (Cv_{RF, min}) for the corresponding reagent test region coefficient of variation (Cv_{TR}) is determined by comparing the color reference field coefficients of variation (Cv_{RF}) of the color reference fields of which a common image was captured together with the corresponding reagent test region; and
deriving, from the training set of pairs of reagent test region coefficients of variation (Cv_{TR}) and corresponding minimum color reference field coefficients of variation (Cv_{RF, min}), a relation for determining the dynamic coefficient of variation limit (Cv_{TR, lim}) for the respective reagent test region by using the corresponding measured minimum color reference field coefficient of variation (Cv_{RF, min}), wherein the dynamic coefficient of variation limit (Cv_{TR, lim}) defines a maximum coefficient of variation (Cv_{TR, max}) for reagent test regions of non-corrupted optical test strips.

14. A computer-readable storage medium comprising instructions which, when executed by a determination system, cause the determination system to carry out at least steps e) and f) according to claim 1.

15. A mobile device having a camera and a processor, the mobile device being configured for performing at least steps iv) to x) of the measurement method according to claim 10.

16. A computer-readable storage medium comprising instructions which, when executed by a mobile device having a camera and a processor, cause the mobile device to carry out at least steps iv) to x) of claim 10.
